(19) United States
(12) Patent Application Publication
(10) Pub. No.: US 2022/0291744 A1
(43) Pub. Date: Sep. 15, 2022

(54) DISPLAY PROCESSING DEVICE, DISPLAY PROCESSING METHOD, AND RECORDING MEDIUM

(71) Applicant: SONY GROUP CORPORATION, TOKYO (JP)

(72) Inventors: KENJI SUGIHARA, TOKYO (JP); TAKURO NODA, TOKYO (JP)

(21) Appl. No.: 17/637,515

(22) PCT Filed: Jul. 17, 2020
(86) PCT No.: PCT/JP2020/027751

§ 371 Date: Feb. 23, 2022

(30) Foreign Application Priority Data
Sep. 3, 2019 (JP) 2019-160042

(51) Int. Cl. G06F 3/01

(52) U.S. Cl. CPC G06F 3/013; G06F 3/017

(57) ABSTRACT

A display processing device includes a control unit (180) that causes a display device to display a spatial object indicating a virtual space. The control unit (180) determines movement of a user in a real space on the basis of a signal value of a first sensor, determines whether or not the user of the display device is gazing at the spatial object on the basis of a signal value of a second sensor, and controls the display device such that visibility of the virtual space indicated by the spatial object is changed on the basis of the determination that the user is gazing at the spatial object and the movement of the user toward the spatial object.

### FIELD

The present disclosure relates to a display processing device, a display processing method, and a recording medium.

### BACKGROUND

In recent years, use of a natural user interface (NUI) has been proposed instead of a user interface in the related art. The NUI realizes a manipulation in a more natural or intuitive motion by a user in a user interface of a computer. The NUI is used, for example, as an input manipulation such as a voice by a user's utterance or the like, or a gesture. Patent Literature 1 discloses a display processing device that temporarily displays a call on a display in association with a region, and selects one command from one or a plurality of commands corresponding to the region relating to the call, as a command regarding the region relating to the call in a case where the call is included in the voice input.

Furthermore, a virtual reality (VR) technology for providing a virtual video to a user as if it is a real event using a display device worn on the head or face of the user, a so-called head mounted display (HMD) has been proposed. Patent Literature 2 discloses a display device in which a display element for inputting a manipulation instruction is displayed on a display unit, and a detection unit captures an image of the whole or a part of the body of the manipulator to detect what kind of motion the manipulator has made with respect to the display element.

### CITATION LIST

### Patent Literature

Patent Literature 1: JP 6102588 B2
Patent Literature 2: JP H8-6708 A

### SUMMARY

### Technical Problem

In the above-described HMD, it is desired to switch functions according to a natural motion of a human without using selection by a user interface, a voice command, a gesture command manipulation, or the like.

Therefore, the present disclosure proposes a display processing device, a display processing method, and a recording medium capable of improving usability while applying a natural user interface.

### Solution to Problem

To solve the problems described above, a display processing device according to the present disclosure includes: a control unit that controls a display device to display a spatial object indicating a virtual space, wherein the control unit determines movement of a user in a real space on the basis of a signal value of a first sensor, determines whether or not the user of the display device is gazing at the spatial object on the basis of a signal value of a second sensor, and controls the display device such that visibility of the virtual space indicated by the spatial object is changed on the basis of the determination that the user is gazing at the spatial object and the movement of the user toward the spatial object.

Moreover, a display processing method, by a computer, according to the present disclosure includes: causing a display device to display a spatial object indicating a virtual space; determining movement of a user in a real space on the basis of a signal value of a first sensor; determining whether or not the user of the display device is gazing at the spatial object on the basis of a signal value of a second sensor; and controlling the display device such that visibility of the virtual space indicated by the spatial object is changed on the basis of the determination that the user is gazing at the spatial object and the movement of the user toward the spatial object.

Moreover, a computer-readable recording medium according to the present disclosure recordes a program for causing a computer to execute: causing a display device to display a spatial object indicating a virtual space; determining movement of a user in a real space on the basis of a signal value of a first sensor; determining whether or not the user of the display device is gazing at the spatial object on the basis of a signal value of a second sensor; and controlling the display device such that visibility of the virtual space indicated by the spatial object is changed on the basis of the determination that the user is gazing at the spatial object and the movement of the user toward the spatial object.

### BRIEF DESCRIPTION OF DRAWINGS

FIG. 1 is a diagram for describing an example of a display processing method according to a first embodiment.

FIG. 2 is a diagram illustrating an example of a relationship between a spatial object and a head mounted display according to the first embodiment.

FIG. 3 is a diagram illustrating another example of a relationship between a spatial object and a head mounted display according to the first embodiment.

FIG. 4 is a diagram illustrating a configuration example of a head mounted display according to the first embodiment.

FIG. 5 is a flowchart illustrating an example of a processing procedure executed by the head mounted display according to the first embodiment.

FIG. 6 is a diagram for describing an example of processing relating to a looking-in determination of the head mounted display.

FIG. 7 is a flowchart illustrating an example of the looking-in determination processing illustrated in FIG. 5.

FIG. 8 is a flowchart illustrating an example of a bending-back determination illustrated in FIG. 5.

FIG. 9 is a diagram for describing an example of the bending-back determination of the head mounted display.

FIG. 10 is a diagram illustrating an example of a presentation mode of the head mounted display according to the first embodiment.

FIG. 11 is a diagram illustrating an example of a presentation mode of a head mounted display according to a first modification of the first embodiment.

FIG. 12 is a diagram illustrating another example of the presentation mode of the head mounted display according to the first modification of the first embodiment.

FIG. 13 is a diagram illustrating another example of the presentation mode of the head mounted display according to the first modification of the first embodiment.

FIG. 14 is a diagram illustrating an example of a presentation mode of a head mounted display according to a second modification of the first embodiment.

FIG. 15 is a diagram illustrating an example of support of a bending-back gesture of a head mounted display according to a third modification of the first embodiment.

FIG. 16 is a diagram illustrating another example of support of the bending-back gesture of the head mounted display according to the third modification of the first embodiment.

FIG. 17 is a diagram illustrating another example of support of the bending-back gesture of the head mounted display according to the third modification of the first embodiment.

FIG. 18 is a diagram illustrating an example of an operation of a head mounted display according to a fourth modification of the first embodiment.

FIG. 19 is a diagram illustrating another example of a spatial object of a head mounted display according to a fifth modification of the first embodiment.

FIG. 20 is a diagram illustrating an example of a spatial object of a head mounted display according to a sixth modification of the first embodiment.

FIG. 21 is a diagram illustrating a display example of a head mounted display according to a second embodiment.

FIG. 22 is a diagram illustrating another display example of the head mounted display according to the second embodiment.

FIG. 23 is a hardware configuration diagram illustrating an example of a computer that implements functions of a display processing device.

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

### First Embodiment

[Configuration of Display Processing Device According to First Embodiment]

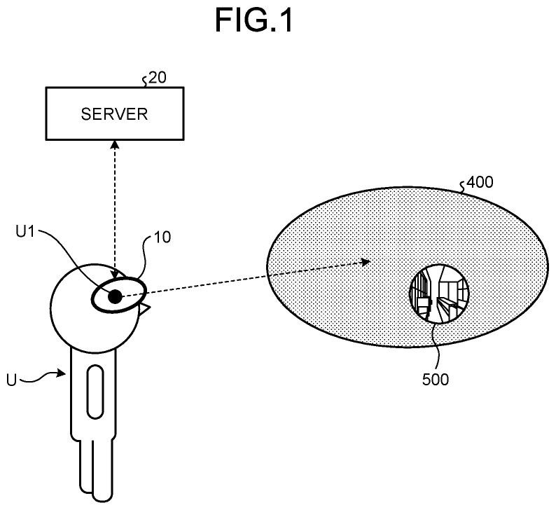

FIG. 1 is a diagram for describing an example of a display processing method according to a first embodiment. As illustrated in FIG. 1, an information processing system includes a head mounted display (HMD) 10, and a server 20. The HMD 10 and the server 20 are configured to be able to communicate via a network or directly communicate without the network, for example.

The HMD 10 is an example of a display processing device which is worn on the head of a user U and in which a generated image is displayed on a display in front of the eyes. Although a case where the HMD 10 is a shielding type in which the entire field of view of the user U is covered will be described, the HMD 10 may be an open type in which the entire field of view of the user U is not covered. The HMD 10 can also display different videos on the left and right eyes U1, and can present a 3D image by displaying an image having parallax with respect to the left and right eyes U1.

The HMD 10 has a function of displaying a real space image 400 to the user U to cause a video see-through state. The real space image 400 includes, for example, a still image, a moving image, and the like. The real space is, for example, a space that can be actually sensed by the HMD 10 and the user U. The HMD 10 has a function of displaying a spatial object 500 indicating a virtual space to the user U. The HMD 10 has a function of adjusting display positions of a left-eye image and a right-eye image to prompt adjustment of convergence of the user. That is, the HMD 10 has a function of causing the user to stereoscopically view the spatial object 500. For example, the HMD 10 presents the spatial object 500 and the real space image 400 to the user U by superimposing and displaying the spatial object 500 on the real space image 400. For example, the HMD 10 presents the spatial object 500 to the user U on a reduced scale by switching the real space image 400 to the spatial object 500 and displaying the spatial object 500.

For example, the HMD 10 displays the real space image 400 and the spatial object 500 in front of the eyes of the user U, and detects a gaze point in the real space image 400 and the spatial object 500 on the basis of the line-of-sight information of the user U. For example, the HMD 10 determines whether or not the user U is gazing at the spatial object 500 on the basis of the gaze point. For example, the HMD 10 displays the real space image 400 and the spatial object 500 in a discrimination visual field of the user U. The discrimination visual field is a visual field in a range in which a human can recognize the shape and content of any type of display object. The HMD 10 can estimate the intention of the user U to move the line of sight of the user U to the spatial object 500, by displaying the spatial object 500 in the discrimination visual field.

For example, in a case where the motion of the user U is assigned as a manipulation without using selection by a graphical user interface (GUI) and a cursor, the HMD 10 generally uses a gesture command. However, in order to clarify the intention of the user U, the gesture command requests the user U to perform a characteristic motion that is not usually performed or a large motion accompanied by movement of the entire body. In addition, if the HMD 10 assigns a natural motion or a small motion as a manipulation in order to ensure the usability, a recognition rate of the gesture command is decreased. In the present embodiment, the HMD 10 and the like are provided which can improve the usability while applying a natural user interface (NUI) as an input manipulation of the user U.

The HMD 10 has a function of providing the NUI as the input manipulation of the user U. For example, the HMD 10 uses a natural or intuitive gesture of the user U as the input manipulation. In the example illustrated in FIG. 1, in a case where the HMD 10 provides the spatial object 500 indicating the content of the virtual space different from the real space to the user U, the NUI is used as the input manipulation. The content of the virtual space includes, for example, an omnidirectional content, a game content, and the like. The omnidirectional content is a content of a video (omnidirectional image) of 360 degrees of the entire circumference, but may be a wide-angle image (for example, 180-degree video) covering at least the entire visual field of the user U.

The virtual space used in the present specification includes, for example, a display space indicating a real space at a position different from the current position of the HMD 10 (user U), an artificial space created by a computer, a virtual space on a computer network, and the like. Furthermore, the virtual space used in the present specification may include, for example, a real space or the like indicating a time different from the current time. In the virtual space, the HMD 10 may express the user U with an avatar, or may express the world of the virtual space from the viewpoint of the avatar without displaying the avatar.

For example, the HMD 10 presents the virtual space to the user U by displaying video data on a display or the like arranged in front of the eyes of the user U. The video data includes, for example, an omnidirectional image capable of viewing a video with an arbitrary viewing angle from a fixed viewing position. The video data includes, for example, a video obtained by integrating (synthesizing) videos of a plurality of viewpoints. In other words, the video data includes, for example, a video in which viewpoints are seamlessly connected, and is a video in which a virtual viewpoint can be generated between viewpoints separated from each other. The video data includes, for example, a video indicating volumetric data in which a space is replaced with three-dimensional data, and is a video in which a position of a viewing viewpoint can be changed without restriction.

The server 20 is a so-called cloud server. The server 20 executes information processing in cooperation with the HMD 10. The server 20 has, for example, a function of providing a content to the HMD 10. Then, the HMD 10 acquires the content of the virtual space from the server 20, and presents the spatial object 500 indicating the content to the user U. The HMD 10 changes a display mode of the spatial object 500 in response to the gesture of the user U using the NUI.

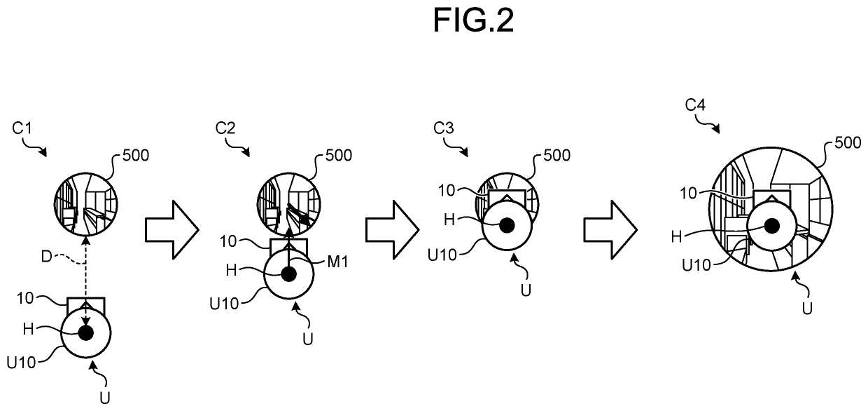

FIG. 2 is a diagram illustrating an example of a relationship between the spatial object 500 and the head mounted display 10 according to the first embodiment. In a scene C1 illustrated in FIG. 2, the HMD 10 displays the spatial object 500 in a reduced size such that the spatial object 500 is visually recognized as being at a position in front of a position H of a head U10 of the user U by a certain distance D. The HMD 10 displays the spatial object 500 at a display position where the head U10 of the user U can be brought close to or can be tilted on the basis of the posture of the user U, for example, an upright state, a seated state, the position H of the head U10, or the like. The spatial object 500 indicates, for example, an object in which an omnidirectional image is pasted on the inner surface of a sphere.

In a case where the user U visually recognizes the spatial object 500, the HMD 10 displays the spatial object 500 such that the image pasted on the inner surface facing a surface viewed by the user U can be visually recognized. That is, the HMD 10 displays the image pasted on the inner surface visually recognized by the user U from the inside of the spatial object 500 as the spatial object 500.

In a scene C2, the user U moves in the real space in a direction M1 toward the spatial object 500 from the current position. In this case, when the movement of the user U is detected by a motion sensor or the like, the HMD 10 obtains a distance between the spatial object 500 and the position H of the head U10 of the user U on the basis of the movement amount and the display position of the spatial object 500. That is, the HMD 10 obtains the distance of the position H on the basis of the position of the user U and the display position of the spatial object 500 in a display coordinate system in which the spatial object 500 is displayed. Then, the HMD 10 recognizes that the distance is more than a set threshold value, that is, the position H of the head U10 is away from the spatial object 500. For example, the threshold value is set on the basis of a display size, the display position, and the like of the spatial object 500 and the viewpoint, the viewing angle, and the like of the user U.

In a scene C3, the user U approaches and looks into the spatial object 500. In this case, similarly to the scene C2, the HMD 10 obtains the distance between the spatial object 500 and the position H of the head U10 of the user U, and recognizes that the distance is closer than the threshold value. As a result, the HMD 10 determines that the user U moves toward the spatial object 500 in the real space, and determines that the user U is gazing at the spatial object 500. As a result, the HMD 10 can detect a gesture of the user U looking in the spatial object 500.

In a scene C4, the HMD 10 changes the visibility of the user U by enlarging the spatial object 500 in response to the looking-in gesture of the user U. Specifically, the HMD 10 enlarges the reduced spatial object 500 to the actual scale, and displays the spatial object 500 such that the center of the spherical spatial object 500 coincides with the viewpoint position (position of the eyeball) of the user U. That is, the HMD 10 can allow the user U to visually recognize the omnidirectional image inside the spatial object 500 by displaying the spherical spatial object 500 such that the spherical spatial object covers the head U10 and the like of the user U. As a result, the user U can recognize that the user U has entered the inside of the spatial object 500 in response to the change of the spatial object 500. Then, when the change in a line-of-sight direction of the user U is detected, the HMD 10 allows the user U to visually recognize all directions of the omnidirectional image by changing the omnidirectional image according to the line-of-sight direction.

As described above, the HMD 10 according to the first embodiment can display the spatial object 500 in front of the user U, and change the visibility of the spatial object 500 in response to the looking-in gesture of the user U with respect to the spatial object 500. As a result, the HMD 10 can reduce the physical load at the time of the input manipulation and shorten the manipulation time as compared with the movement of the entire body of the user U, by using the natural motion of the user U of looking in the spatial object 500.

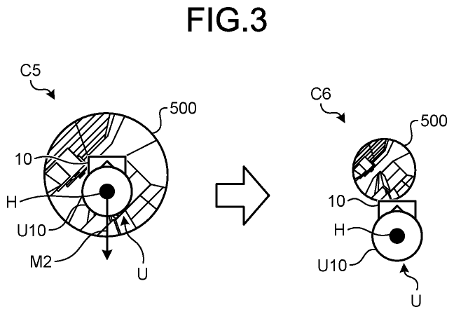

FIG. 3 is a diagram illustrating another example of a relationship between the spatial object 500 and the head mounted display 10 according to the first embodiment. In a scene C5 illustrated in FIG. 3, the HMD 10 displays the spherical spatial object 500 such that the spherical spatial object 500 covers the head U10 and the like of the user U. In this state, the user U performs a motion of pulling (moving) the head U10 in a direction M2 in order to exit the spatial object 500. The direction M2 is a direction opposite to the above-described direction M1. The direction M2 is a direction away from the position where the spatial object 500 is viewed. In this case, when the movement of the head U10 of the user U is detected by a motion sensor or the like, the HMD 10 obtains the movement amount in the spatial object 500. For example, the HMD 10 obtains the movement amount of the head U10 of the user U on the basis of the current position and the center position of the spatial object 500. When the HMD 10 determines that the movement amount exceeds a threshold value for determining the pulling motion, the HMD 10 determines that the user U is in a bending-back gesture that the user U requests deviating from the spatial object 500. The bending-back gesture is, for example, a gesture of the user U moving the head U10 backward.

In a scene C6, the HMD 10 changes the visibility of the user U by reducing the spatial object 500 and displaying the spatial object 500 at a position before the enlarged display, in response to the bending-back gesture of the user U. Specifically, the HMD 10 reduces the spatial object 500 of the actual scale, and displays the spherical spatial object 500 such that the spherical spatial object 500 is visually recognized in front of the user U. That is, the HMD 10 switches the display to the real space image 400, and superimposes and displays the spatial object 500 on the real space image 400 such that the user U visually recognizes the spatial object 500, which has covered the head U10, the visual field, and the like of the user U, from the outside. As a result, the user U can recognize that the user U has exited from the inside of the spatial object 500.

As described above, the HMD 10 according to the first embodiment can change the visibility of the spatial object 500 in response to the bending-back gesture of the head U10 of the user U in a state where the spatial object 500 is displayed on an actual scale. As a result, the HMD 10 can change the visibility of the spatial object 500 by using the natural motion of the user U of bending back the head U10 against the spatial object 500. Furthermore, the HMD 10 can determine whether the user U is looking around the spatial object 500 or wants to exit from the spatial object 500 with high accuracy by setting a gesture of the user U opposite to the looking-in gesture as the bending-back gesture.

[Configuration Example of Head Mounted Display According to First Embodiment]

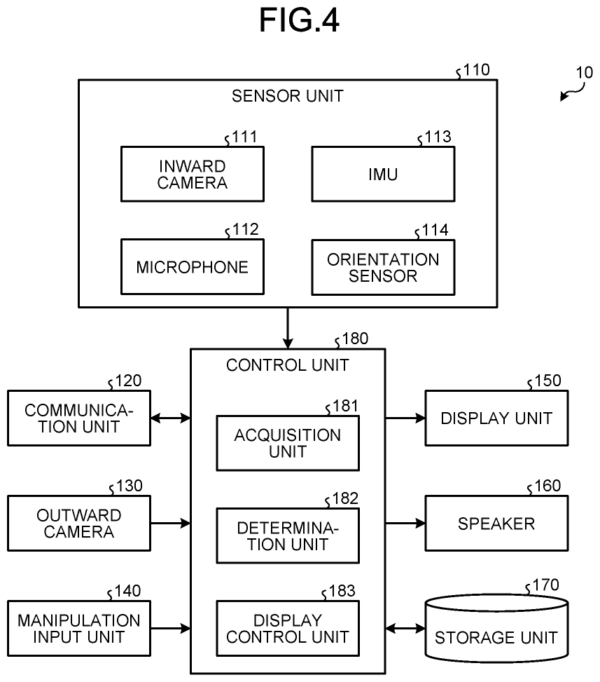

FIG. 4 is a diagram illustrating a configuration example of the head mounted display 10 according to the first embodiment. As illustrated in FIG. 4, the HMD 10 includes a sensor unit 110, a communication unit 120, an outward camera 130, a manipulation input unit 140, a display unit 150, a speaker 160, a storage unit 170, and a control unit 180.

The sensor unit 110 senses the user state or the surrounding situation at a predetermined cycle, and outputs the sensed information to the control unit 180. The sensor unit 110 includes, for example, a plurality of sensors such as an inward camera 111, a microphone 112, an inertial measurement unit (IMU) 113, and an orientation sensor 124. The sensor unit 110 is an example of a first sensor and a second sensor.

The inward camera 111 is a camera that captures an image of the eyes U1 of the user U wearing the HMD 10. The inward camera 111 includes, for example, an infrared sensor or the like having an infrared light emitting unit and an infrared imaging unit. The inward camera 111 may be provided for right eye imaging and left eye imaging, or may be provided only on one of them. The inward camera 111 outputs the captured image to the control unit 180.

The microphone 112 collects the voice of the user U and the surrounding voice (environmental sound or the like), and outputs the collected voice signal to the control unit 180.

The IMU 113 senses the motion of the user U. The IMU 113 is an example of a motion sensor, has a 3-axis gyro sensor and a 3-axis acceleration sensor, and can calculate three-dimensional angular velocity and acceleration. Note that the motion sensor may be a sensor capable of detecting a total of nine axes further including a 3-axis geomagnetic sensor. Alternatively, the motion sensor may be at least one of a gyro sensor and an acceleration sensor. The IMU 113 outputs the detected result to the control unit 180.

An orientation sensor 114 is a sensor that measures a direction (orientation) of the HMD 10. The orientation sensor 114 is realized by, for example, a geomagnetic sensor. The orientation sensor 114 outputs a measurement result to the control unit 180.

The communication unit 120 is connected to an external electronic device such as the server 20 in a wired or wireless manner to transmit and receive data. The communication unit 120 is communicably connected to the server 20 or the like by, for example, a wired/wireless local area network (LAN), Wi-Fi (registered trademark), Bluetooth (registered trademark), or the like.

The outward camera 130 captures an image of the real space, and outputs the captured image (real space image) to the control unit 180. A plurality of outward cameras 130 may be provided. For example, the outward camera 130 can acquire a right-eye image and a left-eye image by a plurality of stereo cameras provided.

The manipulation input unit 140 detects a manipulation input of the user U to the HMD 10, and outputs manipulation input information to the control unit 180. The manipulation input unit 140 may be, for example, a touch panel, a button, a switch, a lever, or the like. The manipulation input unit 140 may be used in combination with the input manipulation by the NUI described above, voice input, and the like. Furthermore, the manipulation input unit 140 may be realized using a controller separate from the HMD 10.

The display unit 150 includes left and right screens fixed to correspond to the left and right eyes U1 of the user U wearing the HMD 10, and displays the left-eye image and the right-eye image. When the HMD 10 is worn on the head U10 of the user U, the display unit 150 is arranged in front of the eyes U1 of the user U. The display unit 150 is provided so as to cover at least the entire visual field of the user U. The screen of the display unit 150 may be, for example, a display panel such as a liquid crystal display (LCD) or an organic electro luminescence (EL) display. The display unit 150 is an example of a display device.

The speaker 160 is configured as a headphone worn on the head U10 of the user U wearing the HMD 10, and reproduces the voice signal under the control of the control unit 180. Furthermore, the speaker 160 is not limited to the headphone type, and may be configured as an earphone or a bone conduction speaker.

The storage unit 170 stores various kinds of data and programs. For example, the storage unit 170 can store information from the sensor unit 110, the outward camera 130, and the like. The storage unit 170 is electrically connected to, for example, the control unit 180 and the like. The storage unit 170 stores, for example, a content for displaying the omnidirectional image on the spatial object 500, information for determining the gesture of the user U, and the like. The storage unit 14 is, for example, a random access memory (RAM), a semiconductor memory element such as a flash memory, a hard disk, an optical disk, or the like. Note that the storage unit 170 may be provided in the server 20 connected to the HMD 10 via a network. In the present embodiment, the storage unit 170 is an example of a recording medium.

In a case where the content is not a content distributed from the server 20 in real time such as a live video, the storage unit 170 can store the content in advance, and reproduce the content even in a state of not being connected to the network.

The control unit 180 controls the HMD 10. The control unit 180 is realized by, for example, a central processing unit (CPU), a micro control unit (MCU), or the like. For example, the control unit 180 may be realized by an integrated circuit such as an application specific integrated circuit (ASIC) or a field programmable gate array (FPGA). The control unit 180 may include a read only memory (ROM) that stores programs to be used, operation parameters, and the like, and a RAM that temporarily stores parameters and the like that change appropriately. In the present embodiment, the control unit 180 is an example of a computer.

The control unit 180 includes functional units such as an acquisition unit 181, a determination unit 182, and a display control unit 183. Each functional unit of the control unit 180 is realized by the control unit 180 executing a program stored in the HMD 10 using a RAM or the like as a work area.

The acquisition unit 181 acquires (calculates) posture information (including a head posture) of the user U on the basis of the sensing data acquired from the sensor unit 110. For example, the acquisition unit 181 can calculate the user posture including the head posture of the user U on the basis of the sensing data of the IMU 123 and the orientation sensor 124. As a result, the HMD 10 can grasp the posture of the user U, the state transition of the body, and the like.

The acquisition unit 181 acquires (calculates) information regarding the actual movement of the user U in the real space on the basis of the sensing data acquired from the sensor unit 110. The information regarding the movement includes, for example, information such as the position or the like of the user U in the real space. For example, movement information including the fact that the user U is walking, the traveling direction, and the like is acquired on the basis of the sensing data of the acquisition unit 1081, the IMU 123, and the orientation sensor 124.

The acquisition unit 181 acquires (calculates) line-of-sight information of the user U on the basis of the sensing data acquired from the sensor unit 110. For example, the acquisition unit 181 calculates the line-of-sight direction and the gaze point (line-of-sight position) of the user U on the basis of the sensing data of an inward camera 121. The acquisition unit 181 may acquire the line-of-sight information using, for example, a myoelectric sensor that detects the motion of muscles around the eyes U1 of the user U, an electroencephalography sensor, or the like. For example, the acquisition unit 181 may acquire (estimate) the line-of-sight direction in a pseudo manner using the above-described head posture (orientation of the head).

The acquisition unit 181 estimates the line of sight of the user U using a known line-of-sight estimation method. For example, the acquisition unit 181 uses a light source and a camera in a case where the line of sight is estimated by the pupil corneal reflex method. Then, the acquisition unit 181 analyzes an image obtained by imaging the eyes U1 of the user U with the camera, detects a bright spot or a pupil, and generates bright spot related information including information regarding the position of the bright spot, and pupil related information including information regarding the position of the pupil. Then, the acquisition unit 181 estimates the line of sight (optical axis) of the user U on the basis of the bright spot related information, the pupil related information, and the like. Then, the acquisition unit 181 estimates the coordinates at which the line of sight of the user U intersects the display unit 150 as a gaze point, on the basis of the positional relationship between the display unit 150 and the eyeball of the user U in a three-dimensional space. The acquisition unit 181 detects the distance from the spatial object 500 to the viewpoint position (eyeball) of the user U.

The determination unit 182 determines the movement of the user U in the real space on the basis of the information regarding the movement acquired by the acquisition unit 181. For example, the determination unit 182 sets the viewpoint position of the user U for which the display of the spatial object 500 has been started, as the viewing position, and determines the movement of the head U10 of the user U on the basis of the viewing position and the acquired position. The viewing position is, for example, a position serving as a reference in a case of determining the movement of the user U.

The determination unit 182 determines whether or not the user U is gazing at the spatial object 500, on the basis of the line-of-sight information indicating the line of sight of the user U acquired by the acquisition unit 181. For example, the determination unit 182 estimates the gaze point on the basis of the line-of-sight information, and determines that the spatial object 500 is gazed in a case where the gaze point is the display position of the spatial object 500.

The display control unit 183 performs generation and display control of an image to be displayed on the display unit 150. For example, the display control unit 183 generates a free viewpoint image from the content acquired from the server 20 in response to the input manipulation by the motion of the user U, and causes the display unit 150 to display the free viewpoint image. The display control unit 183 causes the display unit 150 to display the real space image 400 acquired by the outward camera 130 provided in the HMD 10.

The display control unit 183 causes the display unit 150 to display the spatial object 500 in response to a predetermined trigger. The predetermined trigger includes, for example, the gazing of the user U at a specific target, receiving a start manipulation or a start gesture of the user U, and the like. The display control unit 183 presents the spherical spatial object 500 to the user U by displaying the spherical spatial object 500 on the display unit 150.

The display control unit 183 changes the visibility of the spatial object 500 by changing the display mode of the spatial object 500 in response to the gesture of the user U. The display mode of the spatial object 500 includes, for example, a mode such as a display position and a display size of the spatial object 500. The display control unit 183 causes the display unit 150 to switch between a display mode in which the spatial object 500 is visually recognized from the outside and a display mode in which the spatial object 500 is visually recognized from the inside, in response to the gesture of the user U. In a case where the user U is caused to view a part of the omnidirectional image from the inside of the spatial object 500, when the user U moves the head U10 so that the line of sight is changed, the display control unit 183 displays the other part of the omnidirectional image according to the line of sight on the display unit 150. The control unit 180 controls the display unit 150 such that the visibility of the virtual space is gradually increased as the user U approaches the spatial object 500. Furthermore, in a case where the sound information is associated with the content (omnidirectional image) to be displayed inside the spatial object 500, the display control unit 183 outputs the sound information from the speaker 160.

In the present embodiment, a case where the display control unit 183 causes the display unit 150 to superimpose and display the spatial object 500 in the real space image 400 displayed on the display unit 150 will be described, but the present disclosure is not limited thereto. For example, in a case where the HMD 10 is an open type in which the entire field of view of the user U is not covered, the display control unit 183 may display the spatial object 500 on the display unit 150 so that the spatial object 500 is visually recognized to be superimposed on the scene in front of the user U.

The display control unit 183 has a function of causing the display unit 150 to reduce the spatial object 500 on the basis of the movement of the user U in a direction opposite to the direction in which the user U is viewing in a case where the spatial object 500 is enlarged and displayed. That is, the display control unit 183 changes the display size of the enlarged spatial object 500 to the size before the enlargement, in response to the motion of the user U.

The functional configuration example of the HMD 10 according to the present embodiment has been described above. Note that the configuration described above with reference to FIG. 4 is merely an example, and the functional configuration of the HMD 10 according to the present embodiment is not limited to such an example. The functional configuration of the HMD 10 according to the present embodiment can be flexibly modified according to specifications and operations.

[Processing Procedure of Head Mounted Display 10 According to First Embodiment]

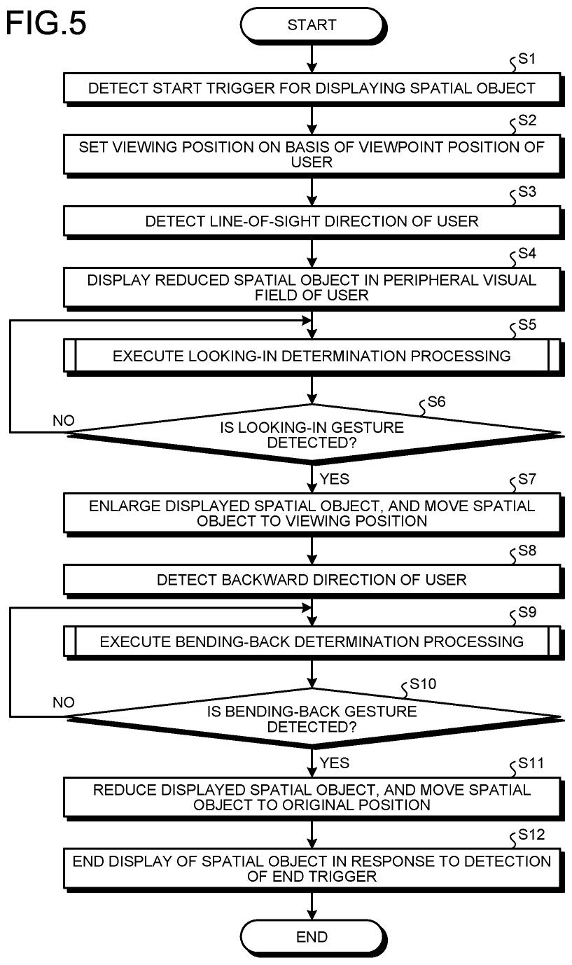

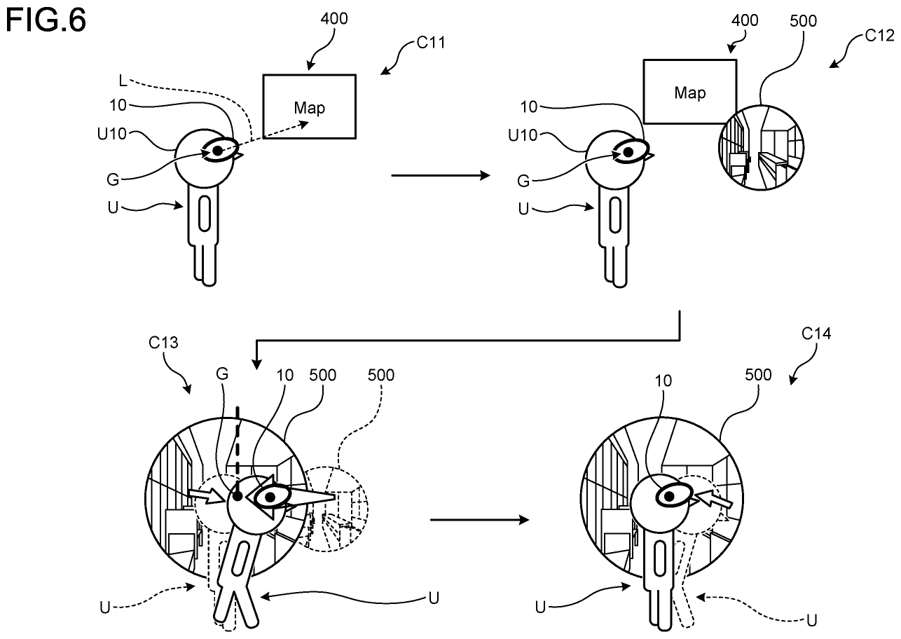

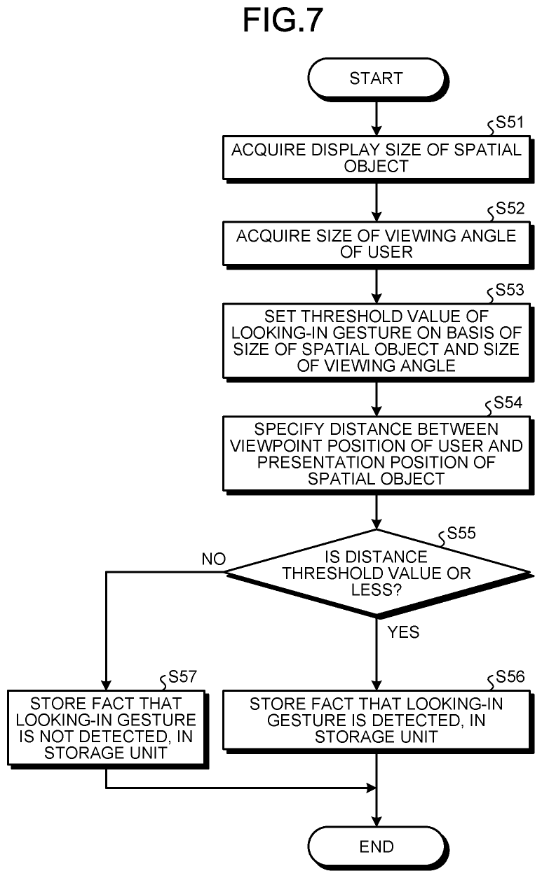

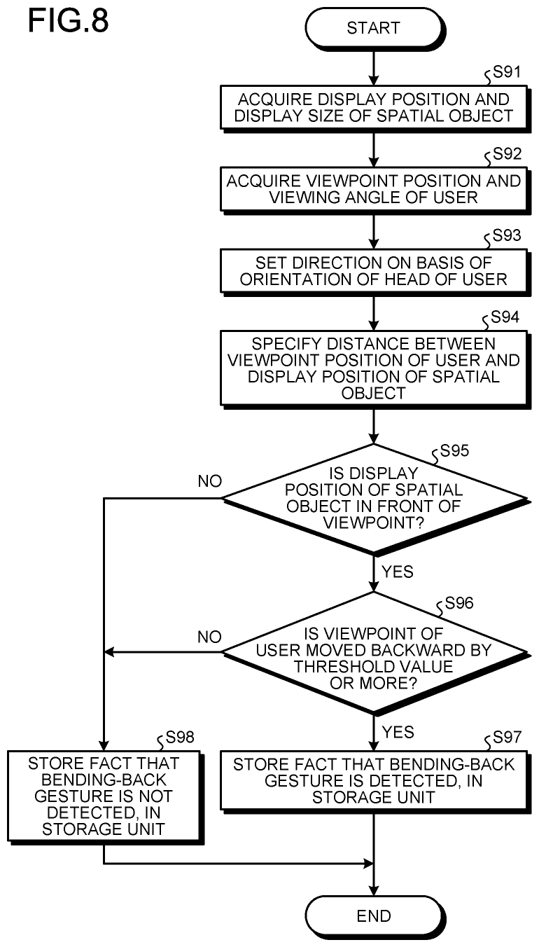

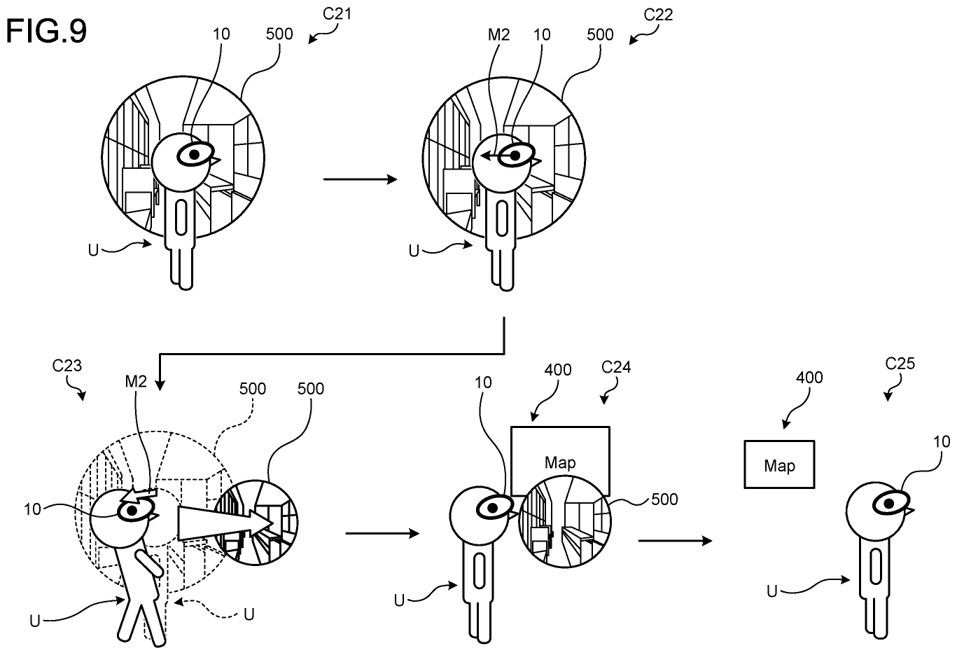

Next, an example of a processing procedure of the head mounted display 10 according to the first embodiment will be described with reference to the drawings of FIGS. 5 to 9. FIG. 5 is a flowchart illustrating an example of the processing procedure executed by the head mounted display 10 according to the first embodiment. FIG. 6 is a diagram for describing an example of processing relating to a looking-in determination of the head mounted display 10. FIG. 7 is a flowchart illustrating an example of the looking-in determination processing illustrated in FIG. 5. FIG. 8 is a flowchart illustrating an example of a bending-back determination illustrated in FIG. 5. FIG. 9 is a diagram for describing an example of the bending-back determination of the head mounted display 10.

The processing procedure illustrated in FIG. 5 is realized by the control unit 180 of the HMD 10 executing a program. The processing procedure illustrated in FIG. 5 is repeatedly executed by the control unit 180 of the HMD 10. The processing procedure illustrated in FIG. 5 is executed in a state where the real space image 400 is displayed on the display unit 150.

As illustrated in FIG. 5, the control unit 180 of the HMD 10 detects a trigger for displaying the spatial object 500 (Step S1). For example, in a scene C11 of FIG. 6, the control unit 180 of the HMD 10 displays the real space image 400 including a map on the display unit 150. Then, for example, the user U gazes at information of a store indicated by the map of the real space image 400. In this case, the control unit 180 estimates a line-of-sight direction L of the user U on the basis of the information acquired from the sensor unit 110, and detects a gaze to a specific target. For example, in a case where the map of the real space image 400 is a floor map, a floor guide, or the like, the map includes information of a plurality of stores. The control unit 180 detects that the user U is gazing at a specific store of the map, as a start trigger. Returning to FIG. 5, when the processing of Step S1 is ended, the control unit 180 advances the processing to Step S2.

The control unit 180 sets a viewing position G on the basis of the viewpoint position of the user U (Step S2). For example, the control unit 180 sets the viewpoint position of the user U when the start trigger is detected, as the viewing position G. The viewing position G is, for example, a position at which the user U views the spatial object 500. The viewing position G is represented by, for example, coordinates in a coordinate system having a reference position in the real space image 400 as an origin. Then, the control unit 180 detects the line-of-sight direction L of the user U (Step S3). For example, the control unit 180 estimates the posture of the head U10 on the basis of the sensing data acquired from the sensor unit 110, and estimates the line-of-sight direction L using the posture of the head U10. When the processing of Step S3 is ended, the control unit 180 advances the processing to Step S4.

The control unit 180 displays the reduced spatial object 500 in a peripheral visual field of the user U (Step S4). The peripheral visual field is, for example, a range of a visual field that deviates from the line-of-sight direction L of the user U and can be recognized in a vague manner. For example, the control unit 180 displays the reduced spatial object 500 on the display unit 150 such that the spatial object 500 is at a position deviated from the line of sight of the user U viewing from the viewing position G. Furthermore, the control unit 180 displays the reduced spatial object 500 on the display unit 150 such that the spatial object 500 is at a position where the visual field of the user U can be covered, by the looking-in motion of the user U from the viewing position G. The control unit 180 displays the spherical spatial object 500 in which the omnidirectional image is pasted inside the sphere, on the display unit 150. In a case where the user U visually recognizes the spatial object 500, the control unit 180 displays the spatial object 500 on the display unit 150 such that only the inner side is visually recognized. For example, the control unit 180 uses culling processing or the like to exclude a surface with its back to the user U out of the inner surfaces of the spatial object 500, from the drawing target. The control unit 180 determines the display position of the spatial object 500 on the basis of the display size of the spatial object 500, the height of the user U, the average value of the visual fields of humans, and the like.

For example, in a scene C12 of FIG. 7, the control unit 180 of the HMD 10 displays the spherical spatial object 500 in the peripheral visual field of the user U viewing the real space image 400. Therefore, in a case of visually recognizing the spatial object 500, the user U needs to move the line of sight from the real space image 400. That is, by detecting that the line of sight of the user U has been moved to the spatial object 500, the control unit 180 can determine whether or not the user U is interested in the spatial object 500. Returning to FIG. 5, when the processing of Step S4 is ended, the control unit 180 advances the processing to Step S5.

The control unit 180 executes the looking-in determination processing (Step S5). The looking-in determination processing is, for example, processing of determining whether or not the user U looks in the spatial object 500, and the determination result is stored in the storage unit 170.

For example, as illustrated in FIG. 7, the control unit 180 acquires the display size of the spatial object 500 (Step S51). The control unit 180 acquires the size of the viewing angle of the user U (Step S52). The control unit 180 sets a threshold value of the looking-in gesture on the basis of the size of the spatial object 500 and the size of the viewing angle (Step S53). For example, the control unit 180 acquires and sets the threshold value corresponding to the size of the spatial object 500 and the size of the viewing angle from the table, the server 20, or the like. When the processing of Step S53 is ended, the control unit 180 advances the processing to Step S54.

The control unit 180 specifies a distance between the viewpoint position of the user U and the display position of the spatial object 500 (Step S54). For example, the control unit 180 obtains the distance between the spatial object 500 and the position H of the head U10 of the user U on the basis of the line-of-sight information of the user U and the like.

The control unit 180 determines whether or not the distance obtained in Step S54 is equal to or less than the threshold value (Step S55). In a case where the control unit 180 determines that the distance is equal to or less than the threshold value (Yes in Step S55), the control unit 180 advances the processing to Step S56. The control unit 180 stores the fact that the looking-in gesture is detected, in the storage unit 170 (Step S56). When the processing of Step S56 is ended, the control unit 180 ends the processing procedure illustrated in FIG. 7, and returns to the processing of Step S5 illustrated in FIG. 5.

In a case where the control unit 180 determines that the distance is not equal to or less than the threshold value (No in Step S55), the control unit 180 advances the processing to Step S57. The control unit 180 stores the fact that the looking-in gesture is not detected, in the storage unit 170 (Step S57). When the processing of Step S57 is ended, the control unit 180 ends the processing procedure illustrated in FIG. 7, and returns to the processing of Step S5 illustrated in FIG. 5.

Returning to FIG. 5, the control unit 180 determines whether or not the looking-in gesture is detected on the basis of the determination result of Step S5 (Step S6). In a case where the control unit 180 determines that the looking-in gesture is not detected (No in Step S6), the control unit 180 returns the processing to Step S5 described above, and continues the determination of the looking-in gesture. On the other hand, in a case where the control unit 180 determines that the looking-in gesture is detected (Yes in Step S6), the control unit 180 advances the processing to Step S7.

The control unit 180 enlarges the displayed spatial object 500, and moves the spatial object to the viewing position G (Step S7). For example, the control unit 180 causes the display unit 150 to enlarge the reduced spatial object 500 and move the spatial object to a position where the head U10 of the user U is covered. Note that, in the present embodiment, the control unit 180 controls the display unit 150 such that the spatial object 500 becomes larger as approaching the user U, but the present disclosure is not limited thereto. For example, the control unit 180 may enlarge the spatial object 500 after moving the spatial object, or may move the spatial object 500 after enlarging the spatial object.

For example, in a scene C13 of FIG. 6, the user U performs an approaching motion of taking one step toward the spatial object 500 from a standing posture and a motion of changing to a forward tilting posture. The control unit 180 of the HMD 10 displays the spatial object 500 on the display unit 150 such that the spatial object 500 that has been reduced and displayed is moved to the viewing position G and is enlarged. For example, in a case where the spatial object 500 is the omnidirectional image, the user U can feel a pseudo motion parallax by the display size. Therefore, the HMD 10 determines the size of the spatial object 500 on the basis of the information of the imaging environment of the outward camera 130. For example, the HMD 10 can set the distance from the ground in the video of the outward camera 130 as the radius of the spherical spatial object 500. As a result, the HMD 10 can provide the feeling of having entered the inside of the spatial object 500 to the user U by the user U visually recognizing the display unit 150.

Thereafter, in a scene C14 of FIG. 6, when the user U has the feeling of having entered the inside of the spatial object 500 after the motion of looking in the spatial object 500, the user U stops the forward tilting posture and returns to the standing state in order to approach a relaxed posture. For example, in the spherical spatial object 500, when the user U views the omnidirectional image from a position other than the center of the sphere, the omnidirectional image is distorted. In the scene C14, since the control unit 180 displays the spatial object 500 on the basis of the viewing position G that is the viewpoint position where the user is in the standing state, the omnidirectional image of the spatial object 500 can be recognized with the viewpoint position of the user U that has returned to the standing state, as the center. As a result, the HMD 10 can cause the user U who has stopped the looking-in gesture (forward tilting posture) to view the omnidirectional image with less distortion.

Returning to FIG. 5, when the processing of Step S7 is ended, the control unit 180 advances the processing to Step S8. The control unit 180 detects a backward direction of the user U (Step S8). For example, the control unit 180 estimates the posture of the head U10 on the basis of the sensing data acquired from the sensor unit 110, and detects a direction opposite to the line-of-sight direction as the backward direction. When the processing of Step S8 is ended, the control unit 180 advances the processing to Step S9.

The control unit 180 executes bending-back determination processing (Step S9). The bending-back determination processing is, for example, processing of determining whether or not the user U visually recognizing the omnidirectional image of the spatial object 500 is bent back, and the determination result is stored in the storage unit 170. For example, as illustrated in FIG. 8, the control unit 180 acquires the display position and the display size of the spatial object 500 (Step S91). The control unit 180 acquires the viewpoint position and the viewing angle of the user U (Step S92). The control unit 180 sets a direction on the basis of the orientation of the head U10 of the user U (Step S93). For example, the control unit 180 sets a forward direction and the backward direction of the head U10 on the basis of the backward direction detected in Step S8.

For example, in a scene C21 of FIG. 9, the HMD 10 causes the omnidirectional image of the spatial object 500 to be recognized with the viewpoint position of the user U as the center. In this case, as illustrated in a scene C22, the control unit 180 sets the direction M2 from the viewpoint position of the user U as the backward direction. Returning to FIG. 8, when the processing of Step S93 is ended, the control unit 180 advances the processing to Step S94.

The control unit 180 specifies a distance between the viewpoint position of the user U and the display position of the spatial object 500 (Step S94). For example, the control unit 180 specifies the distance between the portion displaying the omnidirectional image in the spatial object 500 and the position H of the head U10 of the user U on the basis of the line-of-sight information of the user U and the like.

The control unit 180 determines whether or not the display position of the spatial object 500 is in front of the viewpoint on the basis of the distance specified in Step S94 (Step S95). In a case where the control unit 180 determines that the display position of the spatial object 500 is in front of the viewpoint (Yes in Step S95), the control unit 180 advances the processing to Step S96.

The control unit 180 determines whether or not the viewpoint of the user U is moved backward by the threshold value or more (Step S96). For example, the control unit 180 compares the movement amount of the viewpoint with the threshold value for determining the bending-back gesture, and determines whether or not the viewpoint is moved backward by the threshold value or more on the basis of the comparison result. The threshold value for determining the bending-back gesture is set on the basis of, for example, the movement amount by which the head U10 is moved backward due to the user U bending backward, taking one step back, or the like. In a case where the control unit 180 determines that the viewpoint of the user U is moved backward by the threshold value or more (Yes in Step S96), the control unit 180 advances the processing to Step S97.

The control unit 180 stores the fact that the bending-back gesture is detected, in the storage unit 170 (Step S97). When the processing of Step S97 is ended, the control unit 180 ends the processing procedure illustrated in FIG. 8, and returns to the processing of Step S9 illustrated in FIG. 5.

Furthermore, in a case where the control unit 180 determines that the display position of the spatial object 500 is not in front of the viewpoint (No in Step S95), the control unit 180 advances the processing to Step S98 described later.

Furthermore, in a case where the control unit 180 determines that the viewpoint of the user U is not moved backward by the threshold value or more (No in Step S96), the control unit 180 advances the processing to Step S98. The control unit 180 stores the fact that the bending-back gesture is not detected, in the storage unit 170 (Step S98). When the processing of Step S98 is ended, the control unit 180 ends the processing procedure illustrated in FIG. 8, and returns to the processing of Step S9 illustrated in FIG. 5.

Returning to FIG. 5, when the processing of Step S9 is ended, the control unit 180 advances the processing to Step S10. The control unit 180 determines whether or not the bending-back gesture is detected on the basis of the determination result of Step S9 (Step S10). In a case where the control unit 180 determines that the bending-back gesture is not detected (No in Step S10), the control unit 180 returns the processing to Step S9 described above, and continues the determination of the bending-back gesture. On the other hand, in a case where the control unit 180 determines that the bending-back gesture is detected (Yes in Step S10), the control unit 180 advances the processing to Step S11.

The control unit 180 reduces the displayed spatial object 500, and moves the spatial object to the original position (Step S11). For example, the control unit 180 causes the display unit 150 to reduce the displayed spatial object 500 and move the spatial object from the head U10 of the user U to the original position, that is, the front of the head U10. Note that, in the present embodiment, the control unit 180 controls the display unit 150 such that the spatial object 500 becomes smaller as going away from the user U, but the present disclosure is not limited thereto. For example, the control unit 180 may reduce the spatial object 500 after moving the spatial object, or may move the spatial object 500 after reducing the spatial object.

For example, in a scene C23 of FIG. 9, the user U takes one step backward from the standing posture and bends backward in order to exit from the spatial object 500. The control unit 180 of the HMD 10 detects the bending-back gesture of bending backward in the direction M2 in a state where the spatial object 500 is displayed on the actual scale with the viewing position G as the center. In this case, the control unit 180 causes the display unit 150 to move and reduce the displayed spatial object 500 from the viewing position G to the front of the user U. In this case, as illustrated in a scene C24, the control unit 180 displays the spherical spatial object 500 in the peripheral visual field of the user U viewing the real space image 400. Returning to FIG. 5, when the processing of Step S93 is ended, the control unit 180 advances the processing to Step S12.

The control unit 180 ends the display of the spatial object 500 in response to the detection of an end trigger (Step S12). The end trigger includes, for example, detecting an end manipulation or an end gesture by the user U, detecting movement of the user U by a predetermined distance or more, and the like. For example, the control unit 180 causes the display unit 150 to erase the spatial object 500 displayed in the peripheral visual field of the user U. As a result, the control unit 180 displays only the real space image 400 on the display unit 150 as illustrated in a scene C25 of FIG. 9. Returning to FIG. 5, when the processing of Step S12 is ended, the control unit 180 ends the processing procedure illustrated in FIG. 5.

In the processing procedure illustrated in FIG. 5, the case where the control unit 180 functions as the acquisition unit 181, the determination unit 182, and the display control unit 183 by executing the processing from Step S4 to Step S11 has been described, but the present disclosure is not limited thereto.

In the processing procedure illustrated in FIG. 5, the case where the start trigger for displaying the spatial object 500 is the gaze of the user U has been described, but the present disclosure is not limited thereto. For example, the control unit 180 may detect the start trigger by the voice of the user U using voice recognition. For example, the control unit 180 may detect the start trigger from the gesture of the user U using a camera or the like. Furthermore, the control unit 180 may use a motion sensor or the like for determining the looking-in gesture, and add a characteristic motion of the user U at the time of looking-in, to the determination condition.

The above-described first embodiment is an example, and various modifications and applications are possible.

### First Modification of First Embodiment

For example, the HMD 10 according to the first embodiment can change the presentation mode of the spatial object 500 in response to a gaze state of the user U.

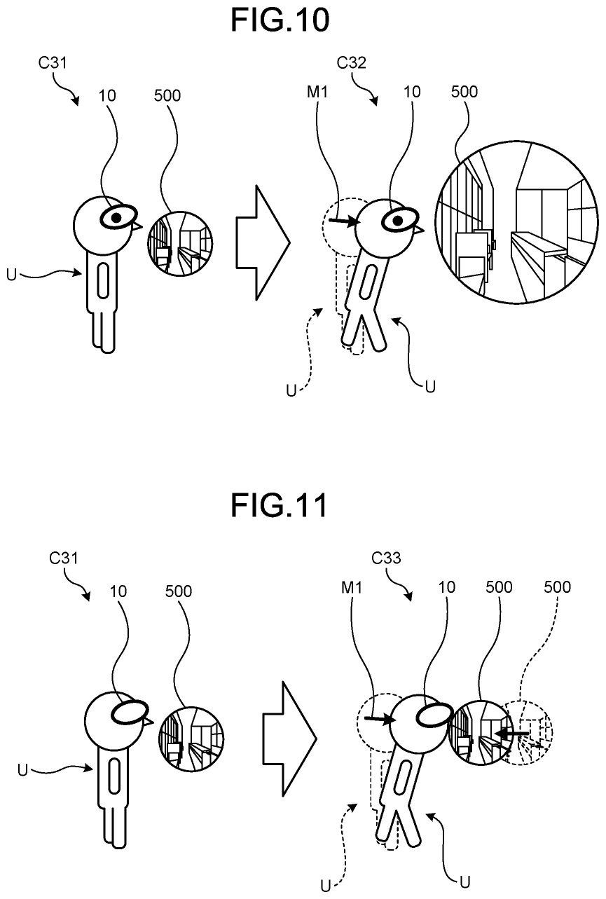

FIG. 10 is a diagram illustrating an example of the presentation mode of the head mounted display 10 according to the first embodiment. In a scene C31 illustrated in FIG. 10, the HMD 10 displays the reduced spatial object 500 on the display unit 150 such that the reduced spatial object is visually recognized in front of the user U.

In a scene C32, the user U moves in the real space in the direction M1 from the position of the scene C31 toward the spatial object 500. In the first embodiment described above, when the HMD 10 detects the approach of the user U to the spatial object 500 on the basis of the detection result of the sensor unit 110, the spatial object 500 is displayed to become larger as the distance between the spatial object 500 and the user U is shorter.

On the other hand, in the first modification of the first embodiment, it is possible to provide the following presentation mode of the spatial object 500.

FIG. 11 is a diagram illustrating an example of the presentation mode of the head mounted display 10 according to the first modification of the first embodiment. Note that the scene C31 of FIG. 11 is in the same state as in FIG. 10.

In a scene C33 illustrated in FIG. 11, the user U moves in the real space in the direction M1 from the position of the scene C31 toward the spatial object 500. In this case, when the HMD 10 detects the approach of the user U to the spatial object 500 on the basis of the detection result of the sensor unit 110, the HMD 10 displays the spatial object 500 on the display unit 150 such that the spatial object is moved toward the head U10 of the user U without changing the size of the spatial object 500. Thereafter, when the HMD 10 detects the looking-in gesture of the user U, the HMD 10 enlarges the spatial object 500 and displays the spatial object 500 on the display unit 150 such that the spatial object is moved to a position where the head U10 of the user U is covered. As a result, the HMD 10 can reduce the movement amount of the user U with respect to the spatial object 500, and thus the usability can be improved.

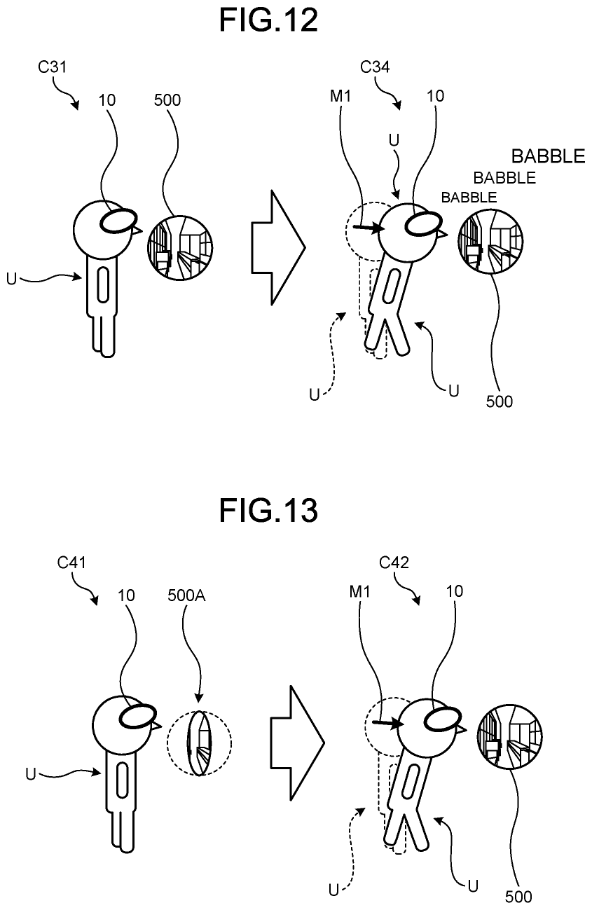

FIG. 12 is a diagram illustrating another example of the presentation mode of the head mounted display 10 according to the first modification of the first embodiment. Note that the scene C31 of FIG. 12 is in the same state as in FIG. 10.

In a scene C34 illustrated in FIG. 12, the user U moves in the real space in the direction M1 from the position of the scene C31 toward the spatial object 500. In this case, when the HMD 10 detects the approach of the user U to the spatial object 500 on the basis of the detection result of the sensor unit 110, the HMD 10 outputs the sound information from the speaker 160 such that the sound information regarding the spatial object 500 becomes larger as the distance between the spatial object 500 and the user U is shorter. As a result, the HMD 10 can excite the user U's interest in the spatial object 500 by presenting the sound information regarding the spatial object 500 to the user U.

FIG. 13 is a diagram illustrating another example of the presentation mode of the head mounted display 10 according to the first modification of the first embodiment. In a scene C41 illustrated in FIG. 13, the HMD 10 displays a spatial object 500A on the display unit 150 such that the spatial object 500 is visually recognized in front of the user U and has a slit shape.

In a scene C42 illustrated in FIG. 13, the user U moves in the real space in the direction M1 from the position of the scene C41 toward the spatial object 500. In this case, when the HMD 10 detects the approach of the user U to the spatial object 500 on the basis of the detection result of the sensor unit 110, the HMD 10 displays the spatial object 500A on the display unit 150 such that a display region of the spatial object 500A is increased as the distance between the spatial object 500A and the user U is shorter. Thereafter, when the distance between the spatial object 500A and the user U reaches a predetermined distance, the HMD 10 displays the above-described spatial object 500 on the display unit 150. As a result, the HMD 10 can excite the user U's interest in the spatial object 500 by deforming the shape of the spatial object 500 according to the distance to the user U.

### Second Modification of First Embodiment

For example, the case where the HMD 10 according to the first embodiment changes the visibility by displaying the spatial object 500 with the viewing position G of the user U as the center in a case where the user U looks in the spatial object 500 has been described, but the presentation mode can be changed to the following presentation mode.

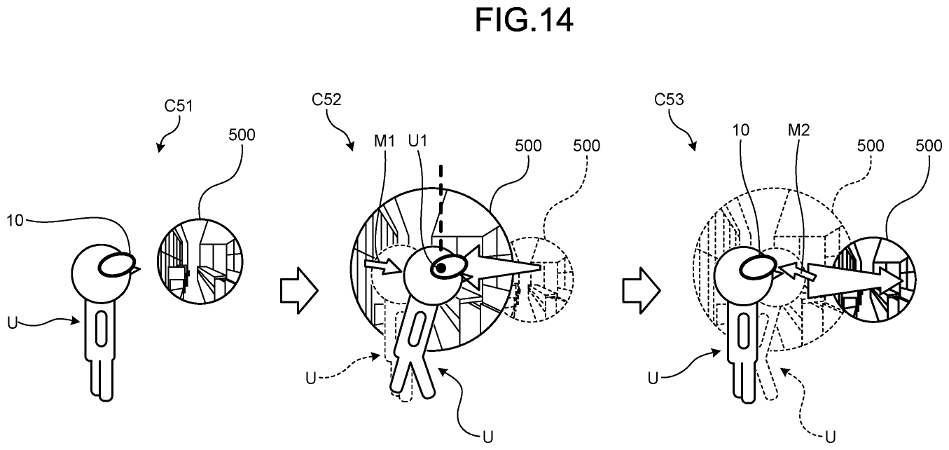

FIG. 14 is a diagram illustrating an example of the presentation mode of the head mounted display 10 according to a second modification of the first embodiment. In a scene C51 illustrated in FIG. 14, the HMD 10 displays the reduced spatial object 500 on the display unit 150 such that the reduced spatial object is visually recognized in front of the user U.

In a scene C52, the user U moves in the real space in the direction M1 from the position of the scene C51 toward the spatial object 500. In this case, when the HMD 10 detects the approach of the user U to the spatial object 500 on the basis of the detection result of the sensor unit 110, the HMD 10 enlarges the displayed spatial object 500, and moves the spatial object 500 such that the position of the eye U1 of the user U is at the center. As a result, the HMD 10 sets the center of the spatial object 500 that the user U has looked in, to the position (viewpoint position) of the eye U1 of the user U, so that the user U can visually recognize the inside of the spatial object 500 in the forward tilting posture.

In a scene C53, the user U is performing a motion of pulling the upper body in the direction M2 so as to return from the forward tilting posture to the original standing posture. In this case, when the detected movement amount satisfies the determination condition of the bending-back gesture, the HMD 10 reduces the spatial object 500, and displays the spatial object 500 on the display unit 150 such that the spatial object is moved to the front of the user U. As a result, the HMD 10 can cause the user U to exit from the spatial object 500 only by the user U returning from the forward tilting posture to the comfortable posture by setting the threshold value of the distance for the determination of the bending-back gesture to be smaller than the looking-in amount.

Note that the HMD 10 according to the second modification of the first embodiment may set the center of the spatial object between the viewpoint position of the user U in the standing posture and the viewpoint position of the user U at the time of looking-in. Furthermore, the HMD 10 may change the center position where the spatial object 500 is displayed, in response to the posture state in a case where the user U views the spatial object 500. For example, in a case where the user U tends to maintain the forward tilting posture for a certain period of time or more, the HMD 10 sets the viewpoint position at the time of the forward tilting posture as the center of the spatial object 500. For example, in a case where the user U tends to return to the standing posture within a certain period of time, the HMD 10 sets the viewpoint position at the time of the standing posture as the center of the spatial object 500.

### Third Modification of First Embodiment

For example, in a case where the user U is viewing the spatial object 500, the HMD 10 according to a third modification of the first embodiment can support the user U to understand the above-described bending-back gesture.

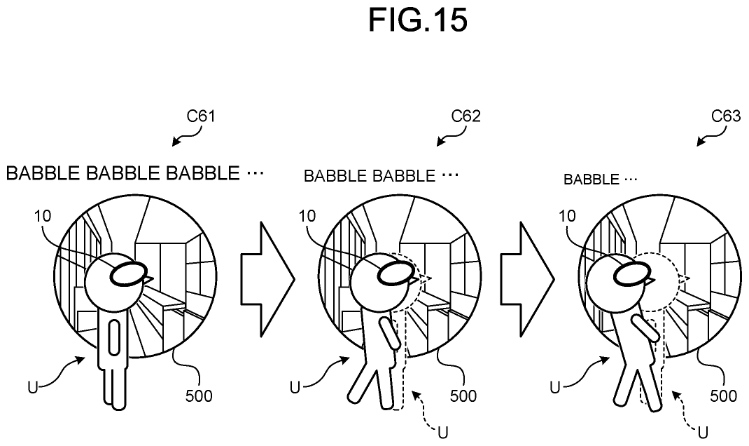

FIG. 15 is a diagram illustrating an example of support of the bending-back gesture of the head mounted display 10 according to the third modification of the first embodiment. In a scene C61 illustrated of FIG. 15, the HMD 10 displays a part of the omnidirectional image of the content inside the spatial object 500 of the actual scale for the user U, and outputs sound information of the content from the speaker 160 with a predetermined volume.

In a scene C62, the user U starts to bend backward from the standing posture. In this case, the HMD 10 detects a first movement amount equal to or less than the threshold value for the bending-back determination, and outputs the sound information of the content from the speaker 160 with a first volume smaller than the predetermined volume.

In a scene C63, the user U further bends backward from the posture of the scene C62. In this case, the HMD 10 detects a second movement amount that is equal to or less than the threshold value for the bending-back determination and is larger than the first movement amount, and outputs the sound information of the content from the speaker 160 with a second volume smaller than the first volume.

In a case where the content to be presented inside the spatial object 500 has the sound information, the HMD 10 illustrated in FIG. 15 can change the volume of the sound information according to the movement state of the user U who is bending back. In this case, the user U feels that the sound is smaller and the sound image is farther as the user U bends back. As a result, the HMD 10 can cause the user to predict how far he or she bends back to exit from the spatial object 500 due to the change in the sound information. As a result, the HMD 10 can cause the user U to recognize the determination state of the bending-back gesture according to the change in the volume of the sound information, and thus it is possible to reduce the load on the body at the time of the bending-back gesture of the user U.

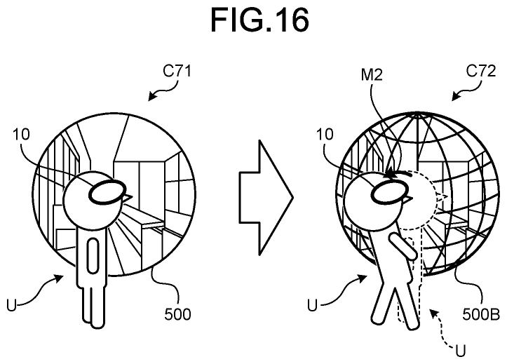

FIG. 16 is a diagram illustrating another example of support of the bending-back gesture of the head mounted display 10 according to the third modification of the first embodiment. In a scene C71 illustrated in FIG. 16, the HMD 10 displays a part of the omnidirectional image of the content inside the spatial object 500 of the actual scale for the user U.

In a scene C72, the user U starts to bend backward from the standing posture. In this case, the HMD 10 detects the movement amount equal to or less than the threshold value for the bending-back determination, and superimposes and displays additional information for recognizing the distance to the spatial object 500, on the omnidirectional image displayed on the inner surface of the spatial object 500. The additional information includes, for example, information such as a mesh, a scale, and a computer graphic model.

The HMD 10 illustrated in FIG. 16 superimposes and displays the additional information on the content to be presented inside the spatial object 500, and thus it is possible to cause the user U to recognize the bending-back amount by the additional information. As a result, the HMD 10 can cause the user to predict how far he or she bends back to exit from the spatial object 500 on the basis of the additional information. As a result, the HMD 10 can cause the user U to recognize the determination state of the bending-back gesture on the basis of the additional information, and thus it is possible to reduce the load on the body at the time of the bending-back gesture of the user U.

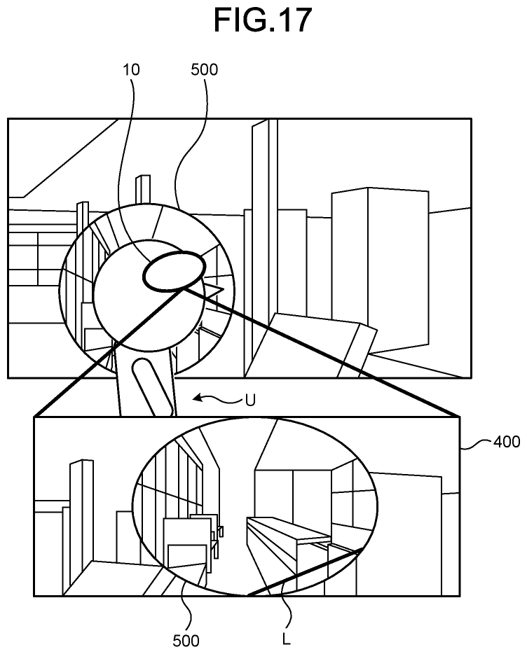

FIG. 17 is a diagram illustrating another example of support of the bending-back gesture of the head mounted display 10 according to the third modification of the first embodiment. As illustrated in FIG. 17, the HMD 10 displays a part of the omnidirectional image of the content inside the spatial object 500 of the actual scale for the user U. Then, the user U starts to bend backward from the standing posture. In this case, the HMD 10 reduces the displayed spatial object 500, and displays the spatial object 500 on the display unit 150 such that the real space image 400 can be visually recognized around the spatial object. Then, the HMD 10 detects the line-of-sight direction L of the user U on the basis of the detection result of the sensor unit 110. In a case where the detected line-of-sight direction L is not directed to the spatial object 500 but is directed to the real space image 400 around the spatial object, the HMD 10 detects a change in the orientation of the line-of-sight direction L as the bending-back gesture. That is, the HMD 10 displays the real space image 400 on a part of the display unit 150 in response to the bending-back of the user U, and detects the bending-back gesture in a case where the change in the line-of-sight direction L to the real space image 400 is detected.

The HMD 10 illustrated in FIG. 17 displays the real space image 400 together with the spatial object 500 in response to the start of the bending-back of the user U, and can determine that the gesture is the bending-back gesture when it is detected that the line-of-sight direction L is directed to the real space image 400. As a result, the HMD 10 can detect the bending-back gesture in response to the bending-back and the change in the line of sight of the user U, and thus it is possible to reduce the load on the body at the time of the bending-back gesture of the user U.

### Fourth Modification of First Embodiment

The case has been described in which the above-described HMD 10 sets the position of the eye U1 of the user U as the viewing position G, and detects the looking-in gesture and the bending-back gesture with reference to the viewing position G. However, in a case where the user U is viewing the omnidirectional image inside the spatial object 500 using the HMD 10, there is a possibility that the user U moves the head U10 to a region of interest in the omnidirectional image or rotates the head U10. Therefore, when the HMD 10 sets the position of the eye U1 of the user U as the viewing position G of the spatial object 500, there is a possibility that the spatial object is viewed at a position deviated from the viewing position G or is not in focus. In such a case, the HMD 10 can change the above-described viewing position G as follows.

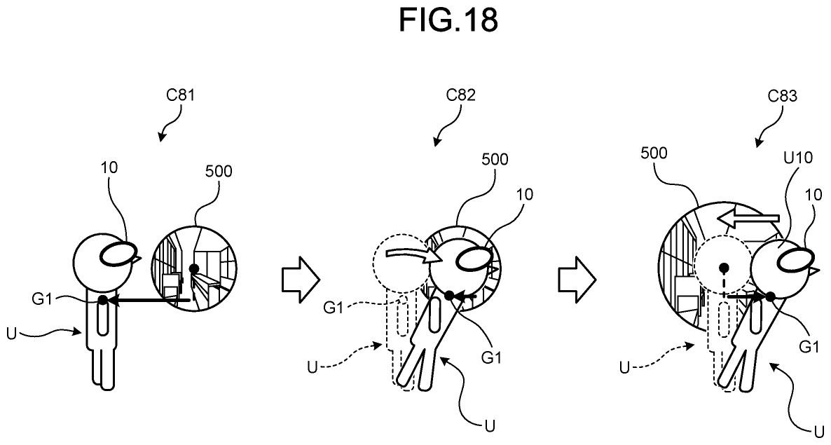

FIG. 18 is a diagram illustrating an example of an operation of the head mounted display 10 according to a fourth modification of the first embodiment. In a scene C81 of FIG. 18, the HMD 10 detects the current position of the HMD 10 by the sensor unit 110, and estimates the position of the neck on the basis of the current position and the body information of the user U. The HMD 10 sets the estimated position of the neck as the viewing position G1. As the viewing position G1, an arbitrary point on the rotation axis of the user U such as the neck position can be set as the viewing position G1. Then, the HMD 10 displays the reduced spatial object 500 on the display unit 150 such that the spatial object is visually recognized in front of the user U with the viewing position G1 as a reference.

In a scene C82, the user U moves in the real space from the position of the scene C81 toward the spatial object 500. In this case, the HMD 10 detects the approach of the neck of the user U to the spatial object 500 on the basis of the detection result of the sensor unit 110. Then, when the distance between the viewing position G and the spatial object 500 is equal to or less than the threshold value, the HMD 10 determines that the gesture is the looking-in gesture, enlarges the spatial object 500, and moves the spatial object to the viewing position G1.

In a scene C83, the user U brings the head U10 close to the omnidirectional image of the spatial object 500. The HMD 10 detects the forward movement of the user U, determines the user U is approaching due to the interest in the omnidirectional image in a case where the detected movement amount is equal to or less than the threshold value, and continues the display of the spatial object 500. Furthermore, in a case where the detected movement amount exceeds the threshold value, the HMD 10 determines that the user has exited from the spatial object 500, and erases the spatial object 500 from the display unit 150 or returns to display of the reduced spatial object 500.

For example, even if the user U performs a motion of looking around, the HMD 10 according to the fourth modification of the first embodiment can suppress adverse effects on detection of the looking-in gesture and the bending-back gesture on the basis of the distance between the position of the neck of the user U and the spatial object 500.

### Fifth Modification of First Embodiment

For example, in a case where the user U is viewing the spatial object 500, the HMD 10 according to a fifth modification of the first embodiment may display a second spatial object 500C, which switches the display to another virtual space or real space, on the inside of the spatial object 500.

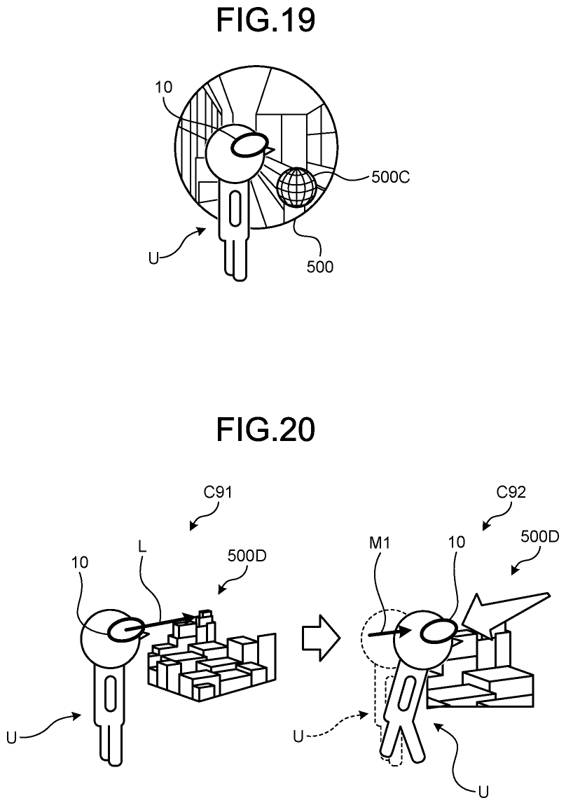

FIG. 19 is a diagram illustrating another example of the spatial object 500 of the head mounted display 10 according to the fifth modification of the first embodiment. In the example illustrated in FIG. 19, the HMD 10 covers the head U10 and the like of the user U with the spatial object 500, and allows the omnidirectional image to be visually recognized inside the spatial object 500. In this case, the HMD 10 reduces and displays the second spatial object 500C indicating an omnidirectional image of another virtual space. Similarly to the spatial object 500, when the HMD 10 detects the looking-in gesture of the user U with respect to the second spatial object 500C, the HMD 10 enlarges the second spatial object 500C, and moves the second spatial object 500C to the viewing position G or a viewing position G1. Thereafter, when the HMD 10 detects the bending-back gesture of the user U viewing the second spatial object 500C, the HMD 10 reduces the second spatial object 500C, and resumes the display of the spatial object 500.

Furthermore, the HMD 10 may reduce and display the second spatial object 500C indicating the omnidirectional image of the real space. In this case, when the HMD 10 detects the looking-in gesture of the user U with respect to the second spatial object 500C, the HMD 10 enlarges the second spatial object 500C, and displays the above-described real space image 400 on the display unit 150.

The HMD 10 according to the fifth modification of the first embodiment can switch display between the real space and the virtual space or switch display between the virtual space and another virtual space only by the looking-in gesture of the user U with respect to the spatial object 500 and the second spatial object 500C. As a result, the HMD 10 can further simplify the usability of the NUI as the user U only needs to look in the spatial object 500 and the second spatial object 500C.

### Sixth Modification of First Embodiment

For example, the HMD 10 according to a sixth modification of the first embodiment may be configured to display volumetric data to the user U instead of the omnidirectional image, when the user U looks in. The volumetric data includes, for example, a point cloud, a mesh, a polygon, and the like.

FIG. 20 is a diagram illustrating an example of a spatial object 500D of the head mounted display 10 according to the sixth modification of the first embodiment. In a scene C91 illustrated in FIG. 20, the HMD 10 displays the spatial object 500D on the display unit 150. The spatial object 500D indicates a predetermined region from a reference point for the volumetric data. The user U is gazing at a specific region in the spatial object 500D in the line-of-sight direction L. In this case, the HMD 10 estimates the line-of-sight direction L on the basis of the detection result of the sensor unit 110, and estimates the region of interest in the spatial object 500D on the basis of a collision position between the line-of-sight direction L and the image. Furthermore, the HMD 10 may estimate the region of interest in the spatial object 500D on the basis of the display position, size, and the like of the spatial object 500D and the line-of-sight direction L.

In a scene C92, the user U looks in the region of interest of the spatial object 500D. When the HMD 10 detects the looking-in gesture of the user U with respect to the region of interest, the HMD 10 moves the spatial object 500D such that the region of interest is in front of the user U, and displays the spatial object 500D on the display unit 150 such that the region of interest is enlarged. Note that the HMD 10 may estimate the degree of interest according to the movement amount of the user U due to the looking-in, and adjust the size of the region of interest according to the degree of interest.

The HMD 10 according to the sixth modification of the first embodiment can change the region of interest of the spatial object 500D only by the looking-in gesture of the user U with respect to the spatial object 500D. As a result, the HMD 10 can further simplify the usability of the NUI because the user U only needs to look in the spatial object 500D.

Note that the first modification to sixth modification of the first embodiment may combine the technical ideas of other embodiments and modifications.

### Second Embodiment

[Outline of Display Processing Device According to Second Embodiment]

Next, a second embodiment will be described. The display processing device according to the second embodiment is the head mounted display (HMD) 10 as in the first embodiment. The HMD 10 includes a display unit 11, a detection unit 12, a communication unit 13, a storage unit 14, and a control unit 15. Note that the description of the same configuration as the HMD 10 according to the first embodiment will be omitted.

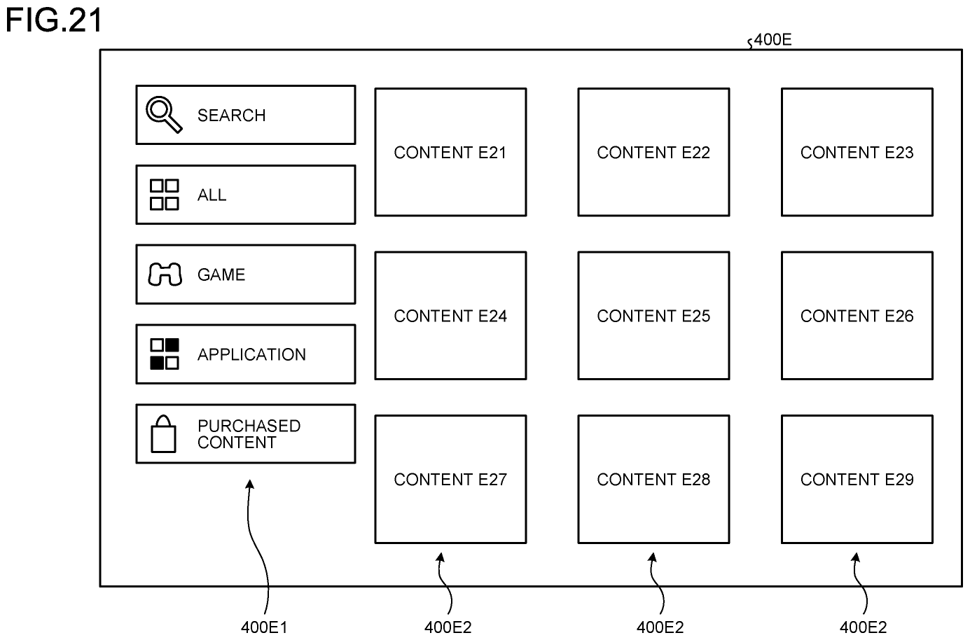

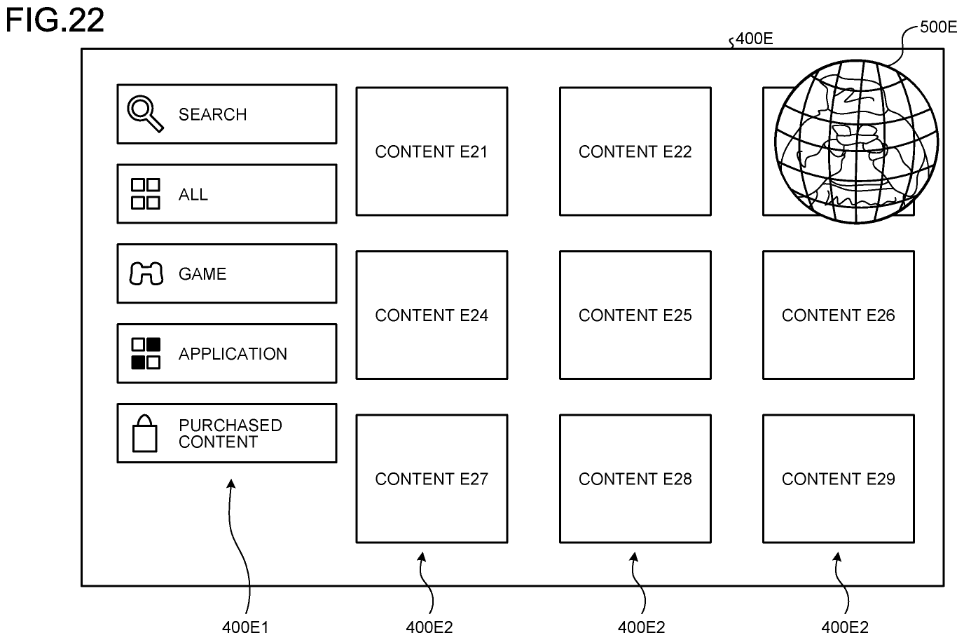

FIG. 21 is a diagram illustrating a display example of the head mounted display 10 according to the second embodiment. FIG. 22 is a diagram illustrating another display example of the head mounted display 10 according to the second embodiment.

As illustrated in FIG. 21, the HMD 10 displays an image 400E indicating a menu of contents on the display unit 150. The image 400E includes a plurality of buttons 400E1 for selecting a menu function and a plurality of icons 400E2 indicating a list of contents. The content includes, for example, a game, a movie, and the like. As a result, the user U recognizes the image 400E in front by visually recognizing the display unit 150, and gazes at the icon 400E2 of a content E25 of interest in the image 400E. Note that the user U may input the region of interest in the image 400E by selecting the icon 400E2 of the content E25 via the manipulation input unit 140 of the HMD 10.

The HMD 10 estimates a region of interest in the image 400E on the basis of the detection result of the sensor unit 110, and recognizes that the region of interest is the icon 400E2 of the content E25. The HMD 10 acquires content data to be presented as a virtual space regarding the content E25 from the server 20 or the like via the communication unit 120. The content data includes, for example, data such as a preview of content and a part of content. In the following description, it is assumed that the HMD 10 has acquired the content data of the content E25.

As illustrated in FIG. 22, when the HMD 10 recognizes that the region of interest is the icon 400E2 of the content E25, the HMD 10 superimposes and displays a spherical spatial object 500E on the image 400E. The HMD 10 displays the spatial object 500E in the vicinity of the icon 400E2 of the content E25 that the user U is interested in. The HMD 10 superimposes and displays the spatial object 500E obtained by reducing the acquired content data, on the image 400E.

In a case where the user U is interested in the spatial object 500E, the user U performs the above-described looking-in gesture with respect to the spatial object 500E. The HMD 10 changes the visibility of the user U by enlarging the spatial object 500E in response to the looking-in gesture of the user U. Specifically, the HMD 10 enlarges the reduced spatial object 500E to the actual scale, and displays the spatial object 500E such that the center of the spherical spatial object 500 coincides with the viewpoint position of the user U. That is, the HMD 10 allows the user to visually recognize the content data inside the spatial object 500 by displaying the spherical spatial object 500E such that the spherical spatial object covers the head U10 and the like of the user U. As a result, the HMD 10 can recognize the content of the content by looking in the spatial object 500E in the image 400E of the menu. Then, when the HMD 10 detects the change in the line-of-sight direction of the user U, the HMD 10 allows the user U to recognize the space of the content by changing the content of the content according to the line-of-sight direction.

As described above, the HMD 10 according to the second embodiment can display the spatial object 500E in front of the user U, and change the visibility of the spatial object 500E in response to the looking-in gesture of the user U with respect to the spatial object 500E. As a result, the HMD 10 can reduce the physical load at the time of the input manipulation and shorten the manipulation time as compared with the movement of the entire body of the user U, by using the natural motion of the user U of looking in the spatial object 500E.

In the second embodiment, the technical ideas of other embodiments and modifications may be combined.

[Hardware Configuration]

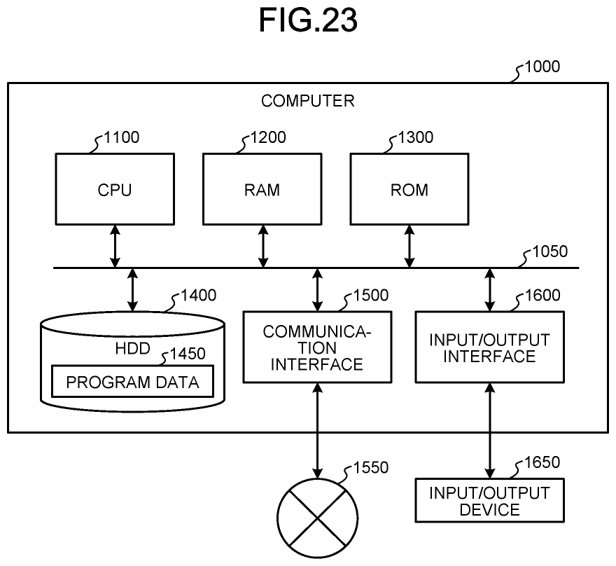

The display processing device according to each of the above-described embodiments is realized by, for example, a computer 1000 having a configuration as illustrated in FIG. 23. Hereinafter, the display processing device according to the embodiment will be described as an example. FIG. 23 is a hardware configuration diagram illustrating an example of the computer 1000 that implements the functions of the display processing device. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records the program according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the display processing device according to the embodiment, the CPU 1100 of the computer 1000 realizes the control unit 15 including the functions of the acquisition unit 181, the determination unit 182, the display control unit 183, and the like by executing the program loaded on the RAM 1200. In addition, the HDD 1400 stores the program according to the present disclosure and data in the storage unit 170. Note that the CPU 1100 executes the program data 1450 by reading the program data 1450 from the HDD 1400, but as another example, may acquire these programs from another device via the external network 1550.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with the above effects or instead of the above effects.

In addition, it is also possible to create a program for causing hardware such as a CPU, a ROM, and a RAM built in a computer to exhibit a function equivalent to the configuration of the display processing device, and also provide a computer-readable recording medium recording the program.

Furthermore, each step according to the processing of the display processing device of the present specification is not necessarily processed in time series in the order described in the flowchart. For example, each step according to the processing of the display processing device may be processed in an order different from the order described in the flowchart, or may be processed in parallel.

### Effects

The HMD 10 includes the control unit 180 that causes the display unit 150 to display the spatial object 500 indicating the virtual space, and the control unit 180 determines movement of the user U in the real space on the basis of a signal value of a first sensor, determines whether or not the user of the display unit 150 is gazing at the spatial object 500 on the basis of a signal value of a second sensor, and controls the display unit 150 such that visibility of the virtual space indicated by the spatial object 500 is changed on the basis of the determination that the user U is gazing at the spatial object 500 and the movement of the user U toward the spatial object 500.

As a result, the HMD 10 can change the visibility of the virtual space indicated by the spatial object 500 as the user U gazes at the spatial object 500 and moves toward the spatial object 500. As a result, the HMD 10 can reduce the physical load at the time of the input manipulation and shorten the manipulation time as compared with the movement of the entire body of the user U, by using the natural motion of the user U gazing at and approaching the spatial object 500. Therefore, the HMD 10 can improve the usability while applying the natural user interface.

In the HMD 10, the control unit 180 controls the display unit 150 such that the visibility of the virtual space is gradually increased as the user U approaches the spatial object 500.

As a result, the HMD 10 can increase the visibility of the virtual space indicated by the spatial object 500 as the user U approaches the spatial object 500. As a result, the HMD 10 can reduce the physical load at the time of the input manipulation and improve the usability of the user U, by using the natural motion of the user U gazing at and approaching the spatial object 500.

In the HMD 10, the control unit 180 controls the display unit 150 such that the reduced spatial object 500 is visually recognized by the user U together with the real space, and causes the display unit 150 to enlarge and display the reduced spatial object 500 when the distance between the user U gazing at the spatial object 500 and the spatial object 500 satisfies a determination condition.

As a result, the HMD 10 can enlarge and display the reduced spatial object 500 according to the distance between the spatial object 500 and the user U by allowing the user U to visually recognize the reduced spatial object 500 together with the real space. As a result, the HMD 10 can enlarge the spatial object 500 by a natural motion of the user U recognizing the spatial object 500 in the real space and gazing at and approaching the spatial object 500, and thus, the manipulation of the user U can be simplified.

In the HMD 10, the control unit 180 detects a looking-in gesture of the user U with respect to the spatial object 500 on the basis of the determination that the user U is gazing at the spatial object 500 and the movement of the user U toward the spatial object 500. The control unit 180 causes the display unit 150 to enlarge and display the reduced spatial object 500 on an actual scale in response to the detection of the looking-in gesture.

As a result, the HMD 10 can enlarge and display the reduced spatial object 500 on an actual scale in response to the detection of the looking-in gesture of the user U with respect to the spatial object 500. As a result, the HMD 10 can realize a novel display switching manipulation without increasing the physical load at the time of the input manipulation, by using the motion of the user U looking in the spatial object 500.

In the HMD 10, the spatial object 500 is a spherical object, and the control unit 180 causes the display unit 150 to display the spatial object 500 that is enlarged to cover at least the head U10 of the user U when the distance between the user U gazing at the spatial object 500 and the spatial object 500 is equal to or less than the threshold value.

As a result, when the distance between the spherical spatial object 500 and the user U is equal to or less than the threshold value, the HMD 10 can enlarge and display the spatial object 500 such that at least the head U10 of the user U is covered. That is, the HMD 10 changes the display form of the spatial object 500 such that the user U can visually recognize the spatial object 500 from the inside. As a result, the HMD 10 can switch the display mode of the spatial object 500 as the distance between the user U and the spatial object 500 becomes shorter, and thus, the usability can be further improved.

In the HMD 10, the control unit 180 controls the display unit 150 such that a part of an omnidirectional image pasted on an inner side of the spatial object 500 can be visually recognized by the user in a case where the spatial object 500 is enlarged.

As a result, in a case where the spherical spatial object 500 is enlarged, the HMD 10 can allow the user U to visually recognize a part of the omnidirectional image pasted on the inner side of the spatial object 500. As a result, the HMD 10 can allow the user U to recognize the virtual space indicated by the spatial object 500 as the distance between the user U and the spatial object 500 becomes shorter, and thus, it is possible to suppress the physical load at the time of the input manipulation and shorten the manipulation time.

In the HMD 10, the control unit 180 controls the display unit 150 such that the viewing position G set on an upper body of the user U, which is different from the position of the viewpoint, becomes the center of the enlarged spatial object 500.

As a result, the HMD 10 enlarges and displays the spherical spatial object 500 with the viewing position G of the user U as the center, so that it is possible to avoid that the user U exits to the outside of the spatial object 500 even when the upper body of the user U moves. As a result, the HMD 10 easily maintains the state of covering the field of view of the user U even when the upper body of the user U moves, and thus, it is possible to suppress deterioration in visibility.

In the HMD 10, the control unit 180 causes the display unit 150 to display the spatial object 500 in a discrimination visual field deviated from the line of sight of the user U, and determines whether or not the user U is gazing at the spatial object 500 on the basis of the signal value of the second sensor.

As a result, the HMD 10 can move the line of sight of the user U to the spatial object 500 by displaying the spatial object 500 in the discrimination visual field of the user U, and thus, it is possible to improve the determination accuracy as to whether or not the user U is gazing at the spatial object 500. As a result, it is possible to avoid the erroneous display even by the HMD 10 controlling the display of the spatial object 500 on the basis of whether or not the user U is gazing at the spatial object 500.

In the HMD 10, the control unit 180 causes the display unit 150 to reduce the spatial object 500 on the basis of the movement of the user U in a direction opposite to a direction in which the user U is viewing in a case where the spatial object 500 is enlarged and displayed.

As a result, the HMD 10 can reduce the spatial object 500 by the movement in the direction opposite to the direction in which the user U gazes at the spatial object 500. As a result, the HMD 10 can reduce the enlarged spatial object 500 by using the natural motion of the user U moving in the direction opposite to the direction in which the user U gazes, and thus, it is possible to further improve the usability of the user U.

In the HMD 10, the control unit 180 detects a bending-back gesture of the user U on the basis of the movement of the user U in the direction opposite to the gazing direction in a case where the spatial object 500 is enlarged and displayed. The HMD 10 controls the display unit 150 to reduce the spatial object 500 and display the reduced spatial object in front of the user U in response to the detection of the bending-back gesture.

As a result, the HMD 10 can reduce and display the enlarged spatial object 500 in response to the detection of the bending-back gesture of the user U in a case where the spatial object 500 is enlarged and displayed. As a result, the HMD 10 can realize a novel display switching manipulation without increasing the physical load at the time of the input manipulation, by using the bending-back motion of the user U in a case where the spatial object 500 is enlarged and displayed.

In the HMD 10, the control unit 180 detects the bending-back gesture on the basis of the distance between the viewing position G set on the upper body of the user U and the display position of the spatial object 500.

As a result, since the HMD 10 sets the viewing position G on the half body of the user U, even when the user U performs a motion such as rotating or tilting the head, the bending-back gesture can be detected without being affected by such a motion. As a result, the HMD 10 can switch the display of the spatial object 500 while suppressing erroneous determination even by using the bending-back gesture, and thus, it is possible to improve the usability.

In the HMD 10, the viewing position G is set to the neck of the user U.

As a result, since the HMD 10 sets the viewing position G on the neck of the user U, even when the user U performs a motion such as rotating or tilting the head, the bending-back gesture can be detected without being affected by such a motion. Furthermore, the HMD 10 can improve the determination accuracy regarding the movement of the user U by setting the viewing position G close to the viewpoint of the user U. As a result, the HMD 10 can switch the display of the spatial object 500 while suppressing erroneous determination even by using the bending-back gesture, and thus, it is possible to improve the usability.

In the HMD 10, the control unit 180 controls an output of the speaker 160 such that the volume of the sound information regarding the spatial object 500 is changed according to the distance between the user U and the spatial object 500.

As a result, the HMD 10 can change the volume of the sound information regarding the spatial object 500 according to the distance between the user U and the spatial object 500. As a result, the HMD 10 can express a sense of distance to the spatial object 500 by changing the volume of the sound information according to the distance, which can contribute to improvement of the usability.

In the HMD 10, the control unit 180 causes the display unit 150 to display the second spatial object 500C indicating another virtual space or the real space, on the inside of the spatial object 500. The HMD 10 controls the display unit 150 such that visibility of a space indicated by the second spatial object 500C is changed on the basis of the determination that the user U is gazing at the second spatial object 500C and the movement of the user U toward the second spatial object 500C.

As a result, the HMD 10 can switch the display between the virtual space and another virtual space or between the virtual space and the real space in response to the movement of the user U with respect to the second spatial object 500C. As a result, since the user U only needs to gaze at and move toward the second spatial object 500C, the HMD 10 can further simplify the usability of the NUI.

A display processing method includes, by a computer, causing the display unit 150 to display the spatial object 500 indicating the virtual space; determining the movement of the user in the real space on the basis of a signal value of a first sensor; determining whether or not the user U of the display unit 150 is gazing at the spatial object 500 on the basis of a signal value of a second sensor; and controlling the display unit 150 such that visibility of the virtual space indicated by the spatial object 500 is changed on the basis of the determination that the user U is gazing at the spatial object 500 and the movement of the user U toward the spatial object 500.

As a result, in the HMD 10, the display processing method can change the visibility of the virtual space indicated by the spatial object 500 as the user U gazes at the spatial object 500 and moves toward the spatial object 500. As a result, the display processing method can reduce the physical load at the time of the input manipulation and shorten the manipulation time as compared with the movement of the entire body of the user U, by using the natural motion of the user U gazing at and approaching the spatial object 500. Therefore, the display processing method can improve the usability while applying the natural user interface.

Note that the following configurations also belong to the technical scope of the present disclosure.

(1)

A display processing device comprising:

a control unit that controls a display device to display a spatial object indicating a virtual space,

wherein the control unit

determines movement of a user in a real space on the basis of a signal value of a first sensor,

determines whether or not the user of the display device is gazing at the spatial object on the basis of a signal value of a second sensor, and

controls the display device such that visibility of the virtual space indicated by the spatial object is changed on the basis of the determination that the user is gazing at the spatial object and the movement of the user toward the spatial object.

(2)

The display processing device according to (1),

wherein the control unit controls the display device such that the visibility of the virtual space is gradually increased as the user approaches the spatial object.

(3)

The display processing device according to (1) or (2),

wherein the control unit

controls the display device such that the reduced spatial object is visually recognized by the user together with the real space, and

causes the display device to enlarge and display the reduced spatial object when a distance between the user gazing at the spatial object and the spatial object satisfies a determination condition.

(4)

The display processing device according to (3),

wherein the control unit

detects a looking-in gesture of the user with respect to the spatial object on the basis of the determination that the user is gazing at the spatial object and the movement of the user toward the spatial object, and

causes the display device to enlarge and display the reduced spatial object on an actual scale in response to the detection of the looking-in gesture.

(5)

The display processing device according to (3) or (4),

wherein the spatial object is a spherical object, and

the control unit causes the display device to display the spatial object that is enlarged to cover at least a head of the user when a distance between the user gazing at the spatial object and the spatial object is equal to or less than a threshold value.

(6)

The display processing device according to any one of (3) to (5),

wherein the control unit controls the display device such that a part of an omnidirectional image pasted on an inner side of the spatial object can be visually recognized by the user in a case where the spatial object is enlarged.

(7)

The display processing device according to (5) or (6),

wherein the control unit controls the display device such that a viewing position set on an upper body of the user, which is different from a position of a viewpoint, becomes a center of the enlarged spatial object.

(8)

The display processing device according to any one of (3) to (7),

wherein the control unit

causes the display device to display the spatial object in a discrimination visual field deviated from a line of sight of the user, and

determines whether or not the user is gazing at the spatial object on the basis of the signal value of the second sensor.

(9)

The display processing device according to any one of (3) to (8),

wherein the control unit causes the display device to reduce the spatial object on the basis of the movement of the user in a direction opposite to a direction in which the user is viewing in a case where the spatial object is enlarged and displayed.

(10)

The display processing device according to (9),

wherein the control unit

detects a bending-back gesture of the user on the basis of the movement of the user in the opposite direction in a case where the spatial object is enlarged and displayed, and

causes the display device to reduce the spatial object and display the reduced spatial object in front of the user in response to the detection of the bending-back gesture.

(11)

The display processing device according to (10),

wherein the control unit detects the bending-back gesture on the basis of a distance between a viewing position set on an upper body of the user and a display position of the spatial object.

(12)

The display processing device according to (11),

wherein the viewing position is set to a neck of the user.

(13)

The display processing device according to any one of (1) to (12),

wherein the control unit controls an output unit such that a volume of sound information regarding the spatial object is changed according to a distance between the user and the spatial object.

(14)

The display processing device according to any one of (1) to (13),

wherein the control unit

causes the display device to display a second spatial object indicating another virtual space or the real space, on the inside of the spatial object, and

controls the display device such that visibility of a space indicated by the second spatial object is changed on the basis of the determination that the user is gazing at the second spatial object and the movement of the user toward the second spatial object.

(15)

The display processing device according to any one of (1) to (14),

wherein the display processing device is used in a head mounted display including the display device disposed in front of eyes of the user.

(16)

A display processing method, by a computer, comprising:

causing a display device to display a spatial object indicating a virtual space;

determining movement of a user in a real space on the basis of a signal value of a first sensor;

determining whether or not the user of the display device is gazing at the spatial object on the basis of a signal value of a second sensor; and

controlling the display device such that visibility of the virtual space indicated by the spatial object is changed on the basis of the determination that the user is gazing at the spatial object and the movement of the user toward the spatial object.

(17)

A computer-readable recording medium recording a program for causing a computer to execute:

causing a display device to display a spatial object indicating a virtual space;

determining movement of a user in a real space on the basis of a signal value of a first sensor;

determining whether or not the user of the display device is gazing at the spatial object on the basis of a signal value of a second sensor; and

controlling the display device such that visibility of the virtual space indicated by the spatial object is changed on the basis of the determination that the user is gazing at the spatial object and the movement of the user toward the spatial object.

(18)

A program for causing a computer to execute:

causing a display device to display a spatial object indicating a virtual space;

determining movement of a user in a real space on the basis of a signal value of a first sensor;

determining whether or not the user of the display device is gazing at the spatial object on the basis of a signal value of a second sensor; and

controlling the display device such that visibility of the virtual space indicated by the spatial object is changed on the basis of the determination that the user is gazing at the spatial object and the movement of the user toward the spatial object.

### REFERENCE SIGNS LIST

10 HEAD MOUNTED DISPLAY (HMD)
110 SENSOR UNIT
120 COMMUNICATION UNIT
130 OUTWARD CAMERA
140 MANIPULATION INPUT UNIT
150 DISPLAY UNIT
160 SPEAKER
170 STORAGE UNIT
180 CONTROL UNIT
181 ACQUISITION UNIT
182 DETERMINATION UNIT
183 DISPLAY CONTROL UNIT
400 REAL SPACE IMAGE
500 SPATIAL OBJECT
500C SECOND SPATIAL OBJECT
G VIEWING POSITION
U USER
U1 EYE
U10 HEAD

1. A display processing device comprising:
a control unit that controls a display device to display a spatial object indicating a virtual space,
wherein the control unit
determines movement of a user in a real space on the basis of a signal value of a first sensor,
determines whether or not the user of the display device is gazing at the spatial object on the basis of a signal value of a second sensor, and
controls the display device such that visibility of the virtual space indicated by the spatial object is changed on the basis of the determination that the user is gazing at the spatial object and the movement of the user toward the spatial object.

2. The display processing device according to claim 1,
wherein the control unit controls the display device such that the visibility of the virtual space is gradually increased as the user approaches the spatial object.

3. The display processing device according to claim 2,
wherein the control unit
controls the display device such that the reduced spatial object is visually recognized by the user together with the real space, and
causes the display device to enlarge and display the reduced spatial object when a distance between the user gazing at the spatial object and the spatial object satisfies a determination condition.

4. The display processing device according to claim 3,
wherein the control unit
detects a looking-in gesture of the user with respect to the spatial object on the basis of the determination that the user is gazing at the spatial object and the movement of the user toward the spatial object, and
causes the display device to enlarge and display the reduced spatial object on an actual scale in response to the detection of the looking-in gesture.

5. The display processing device according to claim 4,
wherein the spatial object is a spherical object, and
the control unit causes the display device to display the spatial object that is enlarged to cover at least a head of the user when a distance between the user gazing at the spatial object and the spatial object is equal to or less than a threshold value.

6. The display processing device according to claim 5,
wherein the control unit controls the display device such that a part of an omnidirectional image pasted on an inner side of the spatial object can be visually recognized by the user in a case where the spatial object is enlarged.

7. The display processing device according to claim 5,
wherein the control unit controls the display device such that a viewing position set on an upper body of the user, which is different from a position of a viewpoint, becomes a center of the enlarged spatial object.

8. The display processing device according to claim 4,
wherein the control unit
causes the display device to display the spatial object in a discrimination visual field deviated from a line of sight of the user, and
determines whether or not the user is gazing at the spatial object on the basis of the signal value of the second sensor.

9. The display processing device according to claim 4,
wherein the control unit causes the display device to reduce the spatial object on the basis of the movement of the user in a direction opposite to a direction in which the user is viewing in a case where the spatial object is enlarged and displayed.

10. The display processing device according to claim 9,
wherein the control unit
detects a bending-back gesture of the user on the basis of the movement of the user in the opposite direction in a case where the spatial object is enlarged and displayed, and
causes the display device to reduce the spatial object and display the reduced spatial object in front of the user in response to the detection of the bending-back gesture.

11. The display processing device according to claim 10,
wherein the control unit detects the bending-back gesture on the basis of a distance between a viewing position set on an upper body of the user and a display position of the spatial object.

12. The display processing device according to claim 11,
wherein the viewing position is set to a neck of the user.

13. The display processing device according to claim 2,
wherein the control unit controls an output unit such that a volume of sound information regarding the spatial object is changed according to a distance between the user and the spatial object.

14. The display processing device according to claim 2,
wherein the control unit
causes the display device to display a second spatial object indicating another virtual space or the real space, on the inside of the spatial object, and
controls the display device such that visibility of a space indicated by the second spatial object is changed on the basis of the determination that the user is gazing at the second spatial object and the movement of the user toward the second spatial object.

15. The display processing device according to claim 1,
wherein the display processing device is used in a head mounted display including the display device disposed in front of eyes of the user.

16. A display processing method, by a computer, comprising:
causing a display device to display a spatial object indicating a virtual space;
determining movement of a user in a real space on the basis of a signal value of a first sensor;
determining whether or not the user of the display device is gazing at the spatial object on the basis of a signal value of a second sensor; and
controlling the display device such that visibility of the virtual space indicated by the spatial object is changed on the basis of the determination that the user is gazing at the spatial object and the movement of the user toward the spatial object.

17. A computer-readable recording medium recording a program for causing a computer to execute:
causing a display device to display a spatial object indicating a virtual space;
determining movement of a user in a real space on the basis of a signal value of a first sensor;
determining whether or not the user of the display device is gazing at the spatial object on the basis of a signal value of a second sensor; and
controlling the display device such that visibility of the virtual space indicated by the spatial object is changed on the basis of the determination that the user is gazing at the spatial object and the movement of the user toward the spatial object.
